(19) United States
(12) Patent Application Publication
(10) Pub. No.: US 2017/0323692 A1
(43) Pub. Date: Nov. 9, 2017

(54) Apparatus, Systems and Methods for Conversion of Scalar Particle Flow to an Electrical Output

(71) Applicant: The Curators of the University of Missouri, Columbia, MO (US)

(72) Inventors: Graham K. Hubler, Highland, MD (US); Joseph Aviles, JR., Tantallon, MD (US)

(21) Appl. No.: 15/487,212

(22) Filed: Apr. 13, 2017

Related U.S. Application Data
(60) Provisional application No. 62/321,910, filed on Apr. 13, 2016.

(51) Int. Cl. G21B 3/00; G21B 1/13; G21K 1/00; G21G 1/12

(52) U.S. Cl. CPC G21B 3/00; G21K 1/00; G21B 1/13; G21G 1/12

(57) ABSTRACT

A scalar particle conversion apparatus, system and method are disclosed. The apparatus includes an anode and a crystalline cathode disposed within an electrolytic fluid or gas. A voltage source is configured to generate a current between the anode and the cathode and one or more components within the electrolytic fluid or gas are loaded into the crystalline cathode. The crystalline cathode generates photons through the interaction between a scalar particle flow and oscillating magnetic hyperfine fields within the crystalline cathode via the inverse Primakoff effect. One or more energy conversion devices are arranged with respect to the crystalline cathode so as to convert the photons or heat from the crystalline cathode to an electrical output.

### CROSS-REFERENCE TO RELATED APPLICATION

The present application claims benefit under 35 U.S.C. §119(e) and constitutes a regular (non-provisional) patent application of U.S. Provisional Application Ser. No. 62/321,910, filed Apr. 13, 2016, entitled SYSTEMS AND METHODS FOR MAXIMIZING PHOTON GENERATION DUE TO THE ANOMALOUS HEAT EFFECT, naming Graham K. Hubler and Joseph Aviles Jr. as inventors, which is incorporated herein by reference in the entirety.

### TECHNICAL FIELD

The present invention generally relates to the inverse Primakoff effect, and, in particular, to a power source for generating an electrical output by directly or indirectly converting photons generated within a material via the inverse Primakoff to an electrical output.

### BACKGROUND

Clean energy sources have long been desirable and with worldwide carbon emission levels on the rise the need for improved clean energy sources is greater than ever before. A number of approaches have been used to supplant carbon-emitting fossil fuel sources, such as, renewable and non-renewable carbon-free energy sources. These sources include solar energy (e.g., photovoltaic technology), wind energy and nuclear energy (e.g., nuclear fission technology). While each of these energy sources has proven promising, they each have their own drawbacks. Solar energy and wind energy suffer from difficulties in widespread adoption due to cost and efficiency. Nuclear energy is expensive and the safety concerns associated with nuclear energy serve as a significant hurdle to increased adoption. As such, it would be desirable to produce an improved clean energy source, which cures the shortcomings of current energy sources noted above.

### SUMMARY

A scalar particle conversion apparatus for conversion of scalar particles to electricity is disclosed, in accordance with one or more embodiments of the present disclosure. In one embodiment, the apparatus includes an anode and a crystalline cathode disposed within an electrolytic fluid. In another embodiment, the apparatus includes a voltage source electrically coupled to the anode and the cathode and configured to generate an electrolysis current between the anode and the cathode, wherein one or more ion species from the electrolytic fluid are loaded into the crystalline cathode. In another embodiment, the crystalline cathode generates photons via an interaction between one or more scalar particles of a scalar particle flow with one or more oscillating magnetic hyperfine fields within the crystalline cathode via an inverse Primakoff effect. In another embodiment, the apparatus includes one or more energy conversion devices operatively coupled to one or more portions of the crystalline cathode and configured to perform at least one of a direct or indirect conversion of the photons from the crystalline cathode to an electrical output.

A scalar particle conversion apparatus for conversion of scalar particles to electricity is disclosed, in accordance with one or more additional and/or alternative embodiments of the present disclosure. In one embodiment, the apparatus includes an anode and a crystalline cathode disposed within a gas. In another embodiment, the apparatus includes a voltage source electrically coupled to the anode and the crystalline cathode and configured to generate a current through the gas, wherein a component of the gas is loaded into the crystalline cathode. In another embodiment, a portion of a scalar particle flow impinging on the crystalline cathode is converted to photons via the inverse Primakoff effect. In another embodiment, the apparatus includes one or more energy conversion devices operatively coupled to one or more portions of the crystalline cathode and configured to perform at least one of a direct or indirect conversion of the photons from the crystalline cathode to an electrical output.

A scalar particle conversion apparatus for conversion of scalar particles to electricity is disclosed, in accordance with one or more additional and/or alternative embodiments of the present disclosure. In one embodiment, the apparatus includes a container. In another embodiment, the apparatus includes a volume of particulate material consolidated within the container, wherein the volume of consolidated particulate material is maintained at a pressure greater than 1 atm. In another embodiment, the apparatus includes one or more heating elements configured to heat the volume of the particulate material to a selected temperature. In another embodiment, a portion of a scalar particle flow impinging on the volume of the particulate material is converted to photons via the inverse Primakoff effect. In another embodiment, one or more energy conversion devices operatively coupled to one or more portions of the volume of the particulate material and configured to perform at least one of a direct or indirect conversion of the photons from the volume of the particulate material to an electrical output.

A solid-state scalar particle detector is disclosed, in accordance with one or more additional and/or alternative embodiments of the present disclosure. In one embodiment, the detector includes a container. In another embodiment, the detector includes a volume of ferromagnetic nanoparticles consolidated within the container in a closely packed suspension. In another embodiment, the detector includes an external magnetic field generator configured to apply an external magnetic field perpendicular to a scalar particle flow impinging on the volume of ferromagnetic nanoparticles, wherein a portion of a scalar particle flow impinging on the volume of ferromagnetic nanoparticles is converted to photons via the inverse Primakoff effect, wherein at least a portion of the photons converted from the scalar particle flow are absorbed by the ferromagnetic nanoparticles to generate heat. In another embodiment, the detector includes a calorimeter. In another embodiment, the container containing the volume of ferromagnetic nanoparticles disposed within the calorimeter, wherein the calorimeter is configured to measure the heat generated by the impingement of the scalar particle flow on the volume of ferromagnetic nanoparticles.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIG. 1A illustrates a graph of radial distribution functions for electron orbitals in platinum, in accordance with one or more embodiments of the present disclosure.

FIGS. 1B-1D illustrate a series of graphs showing excess heat measurements from multiple sources, in accordance with one or more embodiments of the present disclosure.

FIG. 1E illustrates results of a neutron scattering measurement of optical phonons in palladium loaded with hydrogen (PdHx) and palladium loaded with deuterium (PdDx) as a function of loading fraction x, in accordance with one or more embodiments of the present disclosure.

FIG. 2A illustrates a simplified schematic view of an electrolytic-based scalar particle conversion device, in accordance with one or more embodiments of the present disclosure.

FIG. 2B illustrates a simplified schematic view of the cathode of the electrolysis-based scalar particle conversion device depicting the various routes a photon generated within the cathode via the inverse Primakoff effect may take, in accordance with one or more embodiments of the present disclosure.

FIG. 2C illustrates a simplified schematic view of an electrolysis-based scalar particle conversion device serving as a heat source in a steam turbine system, in accordance with one or more embodiments of the present disclosure.

FIG. 2D illustrates a simplified schematic view of an electrolysis-based scalar particle conversion device equipped with a photoelectric conversion device, in accordance with one or more embodiments of the present disclosure.

FIG. 2E illustrates a conceptual view of a palladium crystal loaded with deuterium at interstitial sites within the palladium crystal, in accordance with one or more embodiments of the present disclosure.

FIG. 2F illustrates a simplified schematic view of a triggering source for stimulating phonon resonance within the crystalline cathode, in accordance with one or more embodiments of the present disclosure.

FIG. 2G illustrates excess heat produced as a function of impinging THz radiation on palladium during hydrolysis in lithium deuteroxide (LiOD), in accordance with one or more embodiments of the present disclosure.

FIG. 2H illustrates a simplified schematic view of the orientation of the <100> crystal direction of the crystalline cathode along the direction of travel of the scalar particle flow, in accordance with one or more embodiments of the present disclosure.

FIG. 2I illustrates a simplified schematic view of an external magnetic field generator for polarizing the atoms within the crystalline cathode to enhance the inverse Primakoff effect, in accordance with one or more embodiments of the present disclosure.

FIG. 2J illustrates a conceptual view of the compensation of the Earth's tilt when orientating the crystalline cathode, in accordance with one or more embodiments of the present disclosure.

FIG. 2K illustrates a conceptual view of the compensation of the Earth's tilt when orientating the crystalline cathode and the direction of application of the external magnetic field, in accordance with one or more embodiments of the present disclosure.

FIG. 2L illustrates excess power data measured as a function of time in a foil-based cathode in a heavy water/lithium hydroxide (D₂O/LiOH) electrolyte as an applied magnetic field is rotated with respect to the foil cathode, in accordance with one or more embodiments of the present disclosure.

FIG. 2M illustrates a conceptual view of an experimental layout used to acquire the excess power data measured as a function of time in the foil-based cathode in D₂O/LiOH electrolyte, in accordance with one or more embodiments of the present disclosure.

FIG. 2N-2Q illustrate schematic views of a series of cathodes suitable for implementation in the electrolytic-based scalar particle conversion device, in accordance with one or more embodiments of the present disclosure.

FIG. 2R illustrates a process flow diagram depicting a method of converting scalar particles to an electrical output, in accordance with one or more embodiments of the present disclosure.

FIGS. 3A-3D illustrate a simplified schematic view of an indirect gas-based scalar particle conversion device, in accordance with one or more embodiments of the present disclosure.

FIGS. 4A-4B illustrate a simplified schematic view of a direct gas-based scalar particle conversion device, in accordance with one or more embodiments of the present disclosure.

FIG. 4C illustrates a process flow diagram depicting a method of converting scalar particles to an electrical output with a gas-based conversion device, in accordance with one or more embodiments of the present disclosure.

FIGS. 5A-5C illustrate a simplified schematic view of a solid state scalar particle conversion device, in accordance with one or more embodiments of the present disclosure.

FIG. 5D illustrates a process flow diagram depicting a method of converting scalar particles to an electrical output with a solid state conversion device, in accordance with one or more embodiments of the present disclosure.

FIG. 6A illustrate a simplified schematic view of a solid state scalar particle detector, in accordance with one or more embodiments of the present disclosure.

FIG. 6B illustrates a process flow diagram depicting a method of detecting scalar particles, in accordance with one or more embodiments of the present disclosure.

### DETAILED DESCRIPTION OF THE INVENTION

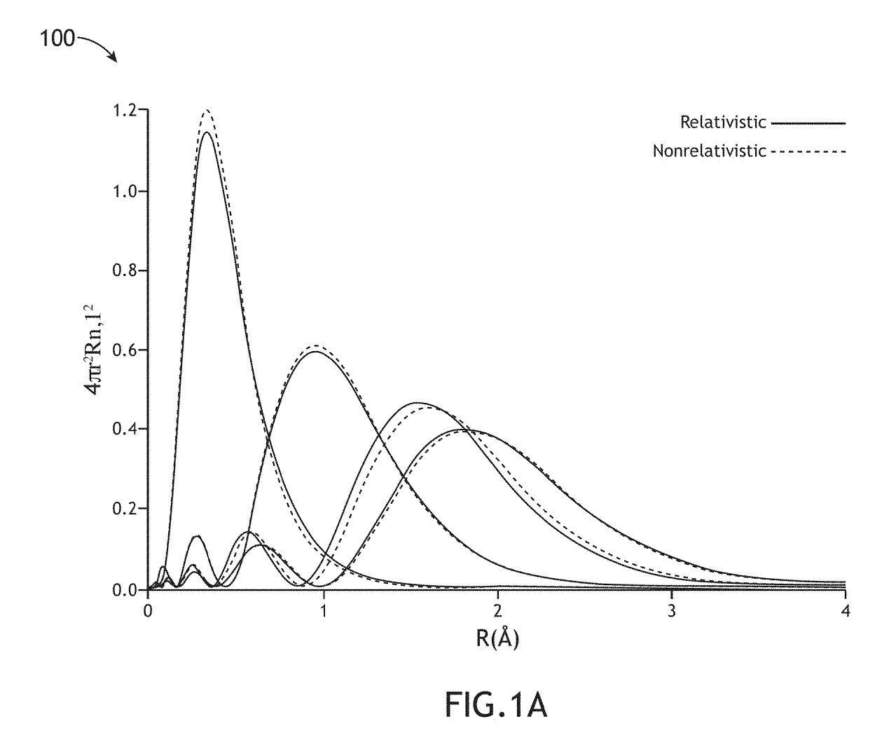

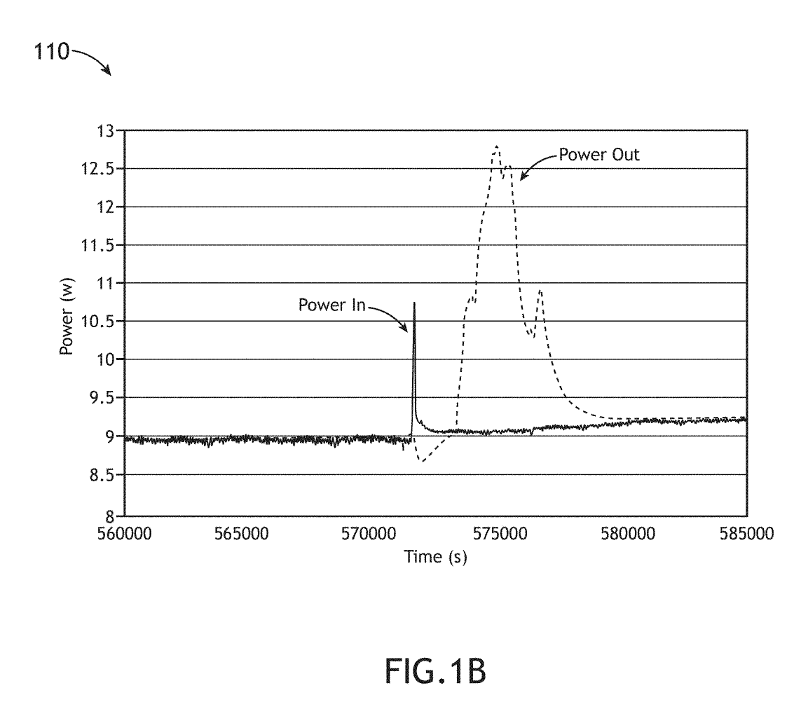

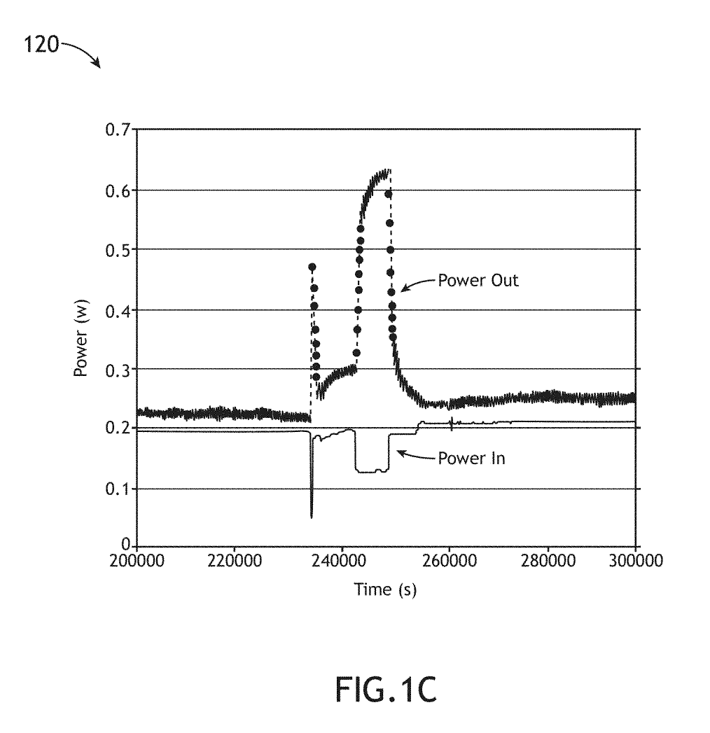

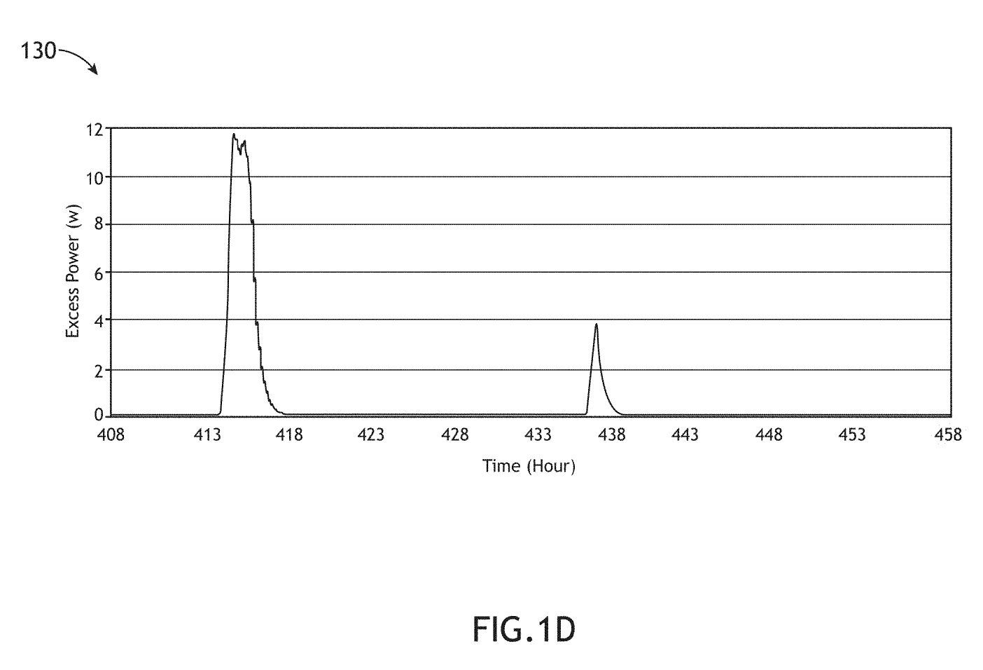

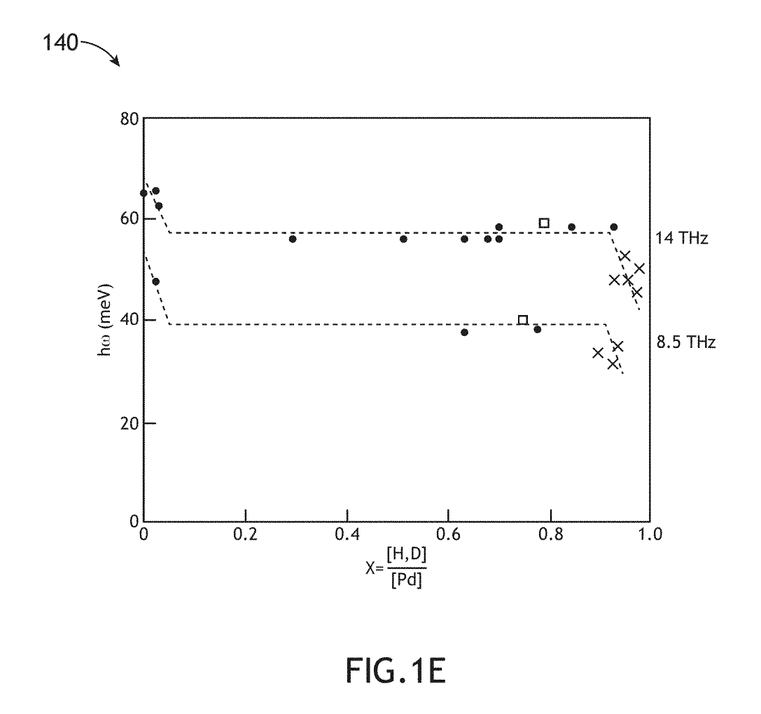

Reference will now be made in detail to the subject matter disclosed, which is illustrated in the accompanying drawings. Referring generally to FIGS. 1A-6B, embodiments of the present disclosure are directed to a system for converting scalar particle flow to an electrical output and methods of operation and forming the same.

Embodiments of the present disclosure are directed to conversion devices configured for converting a scalar particle flow to an electrical output via the inverse Primakoff effect. The conversion devices of the present disclosure achieve the scalar particle-to-electrical output conversion through the establishment and/or maintenance of oscillating magnetic hyperfine fields, which occupy a significant volume of a crystalline component (e.g., crystalline cathode) of the conversion devices and are modulated by electron and phonon resonances within the crystalline component. The natural phonon/electron resonances within the crystalline component provide a momentary, or oscillating, electronic phase transition that may produce a colossal magnetic hyperfine field within the crystalline component sufficient to efficiently convert scalar particles or axion-like particles (ALPs) impinging on the crystalline component into photons. In some instances, the photons generated by the inverse Primakoff effect are internally absorbed by the crystalline component, thereby generating a heat. The converted photons are responsible for the anomalous heat effect and can be detected by IR and RF spectroscopies or calorimetry. In additional embodiments, the conversion devices of the present disclosure may convert the photon output (direct conversion) or the heat output (indirect conversion) form the crystalline component to an electrical output.

It is disclosed herein that very large oscillating magnetic hyperfine fields in crystals, driven by a stimulus, such as an electrolysis current, may fill a significant volume of a solid crystalline component. The resonating crystal field established within the crystalline component of the conversion devices of the present disclosure may convert scalar particles in the mass range of 10⁻³ to 1 eV into photons via the inverse Primakoff effect provided that the crystal resonates at the scalar particle mass frequency.

The conversion of scalar particles into photons is responsible for the anomalous heat effect and can be detected by infrared (IR) and radio frequency (RF) spectroscopies or calorimetry. The anomalous heat effect (AHE) is associated with excess energy observed in the form of heat in cathodes electrolyzed in an electrolysis fluid. AHE is most pronounced in palladium (Pd) cathodes electrolyzed in heavy water (D₂O) and is much less evident when light water (H₂O) is used. The AHE is generally discussed in G. K. Hubler, “Anomalous Effects in Hydrogen-Charged Pd—A Review”, Surf. Coatings Tech., 201 (2007) 8568; V. Violante, E. Castagna, S. Lecci, F. Sarto, M. Sansovini, A. Torre, A. LaGatta, R. Duncan, G. K. Hubler, A. El-Boher, O. Azizi, D. Pease, D. Knies and M. McKubre, “Review of materials science for studying the Fleishmann-Pons Effect”, Cur. Sci. 108 (2015) 540; D. L. Knies, K. S. Grabowski, G. K. Hubler, J. H. He and V. Violante, “Are Oxide Interfaces Necessary in Fleishmann-Pons-Type Experiments?”, J. Condensed Matter Nucl. Sci. 8 (2012) 219; and O. Azizi, A. El-Boher, J. H. He, G. K. Hubler, D. Pease, W. Isaacson, V. Violante and S. Gangopadhyay, “Progress towards understanding anomalous heat effect in metal deuterides”, Cur. Sci., 108 (2015) 565, which are each incorporated herein by reference in the entirety.

It is disclosed herein that very large oscillating magnetic hyperfine fields in crystals, driven by a stimulus, such as an electrolysis current, may fill a significant volume of a solid crystalline component. The resonating crystal field established within the crystalline component of the conversion devices of the present disclosure may convert scalar particles in the mass range of 10⁻³ to 1 eV into photons via the inverse Primakoff effect provided that the crystal resonates at the scalar particle mass frequency.

### I. Origin of Hyperfine Magnetic Field

It is noted herein that there exists ample evidence for the existence of large crystal fields. Proton channeling in poled BaTiO₃ crystals detected an electric field greater than 10̂11 V/m in a volume around the atoms of the crystals with spherical radius of 0.17 nm. The presences of large electric fields in crystals is discussed in D. S. Gemmell and R. C. Mikkelson, “Channeling of protons in thin BaTiO₃ crystals at temperatures above and below the ferroelectric curie point,” Phys. Rev. B6 (1972) 1613, which is incorporated herein by reference in the entirety. Transient magnetic fields at nuclei have been measured up to 5,000 Tesla and caused by the high energy nuclei (˜MeV) slowing down in a magnetically polarized ferromagnet and are discussed in N. Benczer-Koller and G. J. Kumbartzki, “Magnetic moments of short-lived excited nuclear states: measurements and challenges,” J. Phys. G: Nucl. Part. Phys. 34 (2007) R321, which is incorporated herein by reference in the entirety. This field is caused by more frequent scattering of the nucleus with electrons polarized up then down with respect to the external polarizing field and by pick-up of polarized electrons in atomic s-shells. Static hyperfine magnetic fields range from negligible values to 2000 Tesla. Static hyperfine magnetic fields are discussed in G. H. Rao, “Table of hyperfine fields for impurities in Fe, Co, Ni, Gd and Cr,” Hyperfine Interactions 24-26 (1985) 1119; R. W. Dougherty, Surya N. Panigrahy and T. P. Das. “Calculation of the hyperfine fields in the noble-metal atoms,” Phys. Rev. A47 (1993) 2710; and P. Novak and V. Chlan, “Contact hyperfine field at Fe nuclei from density functional calculations,” Phys. Rev. B81 (2010) 174412, which are each incorporated herein by reference in the entirety. Static hyperfine magnetic field magnitudes for several materials are listed in Table I provided below:

TABLE I
Static magnetic hyperfine field at the nuclear of
several solutes in ferromagnetic hosts.

| Solute | Host | Field (T) |
|---|---|---|
| Pd | Fe | −60 |
| Ni | CuNiCrO | 80 |
| Ni | NiCrFeO | 63 |
| Sm | Fe | 274 |
| Au | Fe | 2000 |

It is noted that the hyperfine field at a nucleus in a solid arises from the magnetic properties of the nuclei's own electrons. It is further noted that the magnetic hyperfine field H is caused by the spin and orbital angular momentum of the surrounding electrons and is described by:

\vec{H}=g_{S}μ_{B}{\vec{l}/r³+[3\vec{r}(\vec{s}·\vec{r})/r⁵−\vec{s}/r³]+8πδ(r)\vec{s}/3} Eq. 1

where gₛ is the electron spin g-factor, μ_{B} is the Bohr magneton, I is the orbital angular momentum, s is the spin angular momentum, and r is the electron-nucleus distance. Equation 1 must be summed all over the electrons of the atom to obtain the resultant field at the nucleus. The first term accounts for the magnetic field of circulating electron charge. The second term accounts for the magnetic dipole moment of the electron. The third term (Fermi contact term) accounts for the s-electron wave function overlap at the nucleus.

Taking iron as an example, which has an electron configuration ([Ar] 4s² 3d⁶), the hyperfine field due to the 1s, 2s, and 3s shells is commonly called core polarization (CP). Core Polarization arises from the spin exchange interaction between the partially filled 3d shell electrons and the s electrons. In the atom, s electrons with spin parallel to the net 3d electron spin experience a different exchange interaction from those s electrons having antiparallel spin. The result of this is that electrons with different spin have different wave functions, and therefore different spin densities. In this model, the magnitude of the CP induced field should be proportional to the spin imbalance in the 3d shell that is closely proportional to the local magnetic moment (2.22 Bohr Magnetons for Fe). The CP field contribution should be approximately independent of the surrounding lattice since it is due to an interaction localized within the atom.

It is noted that the 4s contribution to the hyperfine field is more complicated than the 1s, 2s and 3s contributions. In the case of iron, the 4s electrons are in the conduction band of the solid. The conduction electron polarization (CEP) can be visualized as having two contributions: 1) self-polarization of the s-like conduction electrons by spin exchange in the atom; and 2) the sum of the CEP effects from all the neighbors of the atom. In iron, both of these contributions are proportional to the iron host magnetic moment (mₕ), since the local moment (m_{L}) and the nearest neighbor moments (mₙₙ) are the same.

The field due to the Fermi-contact term may be written as:

H_{C}=(8π/3)g_{S}μ_{B}\vec{s}Σ{|Ψ↑ₙₛ(0)|²−|Ψ↓ₙₛ(0)|²} Eq. 2

where the delta function in Eq. 1 is replaced by the electron wave function at r=0, and the arrows refer to the spin direction of s electrons of principal quantum number n, relative to the 3d electron spin direction in iron. It is noted that s-electrons produce the largest field in transition metals through the Fermi contact term and the overlap of the s-electron wave function with the nucleus. In Rare Earth nuclei, the partially occupied f-shell contributes the largest field through orbital magnetic moment (first term in Eq. 1).

### II. Volume Filling Aspect of Hyperfine Magnetic Field

It is noted that the discussion above related to the origin of magnetic hyperfine fields assumes that the nucleus is at a substitutional lattice site with no near neighbor defects. This assumption underlies nearly all measurements in the literature of hyperfine fields. The magnetic field is measured at the position of the nucleus by perturbed angular correlations (PAC), the Mossbauer Effect or NMR, which is discussed in F. Probst and F. E. Wagner, “Mossbauer study of the hydrogen distribution near iron and cobalt solutes in palladium hydride,” J. Phys F: Met. Phys. 17 (1987) 2459, which is incorporated herein by reference in the entirety. It is noted that if the iron is at an interstitial site, the CEP term may undergo a drastic change in magnitude, or even change sign. The CP term would not likely be greatly affected, since it is relatively independent of the surrounding atoms. The 4s electron spin density contributions have been measured from nine nearest neighbor sites for Si in Fe in A. W. Overhauser and M. B. Stearns, “Spin susceptibility of conduction electrons in iron,” Phys. Rev. Lett. 13 (1964) 316, which is incorporated herein by reference in the entirety. The data collected by Overhauser and Stearns displays strong oscillatory behavior and shows that spin polarization is positive at the nucleus (R<0.5) and is negative in the interstitial position between iron atoms. It is evident that the sum of the spin density contributions from all the nearest neighbors of an interstitial will, in general, be different from the sum at a lattice site, and consequently, will result in a different hyperfine field. Similarly, an iron atom at a lattice site with a vacancy or interstitial as a nearest neighbor would also have its CEP hyperfine field contribution altered.

An approach to determine the static hyperfine field at any arbitrary point in an atom is provided here. It is noted that Equation 2, which describes CP and CEP, can be evaluated at any arbitrary point in the atom. It is further noted that both CP and CEP effects will be present at distances from the nucleus. The magnetic field at an arbitrary point can be estimated from the electron wave functions generated by Hartree-Fock and DFT calculations or simple estimates can be obtained from general s electron orbitals.

FIG. 1A illustrates a graph 100 depicting the radial distribution function of s electrons in a Pt atom. For the purposes of consideration here, if it is assumed that the 6s shell contain 1 electron then from the Fermi contact term in Eq. 2, the local magnetic field is very large and is highest at the peaks of the radial distribution function and is present throughout the atomic shells except at the nodes. FIG. 1A also shows that the magnetic field caused by the unpaired 6s electron at any point in the atom is highly non-uniform.

To relate this putative internal field to the macroscopic internal field, if it is assumed that the field is present out to the 6s shell, and that it is uniform inside this spherical shell with a value Hᵢ, then the effective macroscopic magnetic field can be estimated by using the analogy of dielectric effective medium theory (EMT). Dielectric effective medium theory is discussed in Y. Wu, X. Zhao, F. Li & Z. Fan, “Evaluation of mixing rules for dielectric constants of composite dielectrics by MC-FEM calculation on 3D cubic lattice”, Journal of Electroceramics, 11, 227-239, 2003, which is incorporated herein by reference in the entirety. Under simple Bruggeman EMT, using a fill factor of 0.6 for the sphere, the effective magnetic field is estimated to be 0.6 Hᵢ.

### III. High Frequency Dynamic Aspect of Hyperfine Magnetic Field

Hyperfine magnetic fields are generally referred to as “static” since the measured value is a time averaged quantity. The best time resolution for these measurements to date is ˜1 ps, but is normally ˜1 ns. Time resolution of hyperfine magnetic fields on the order of 1 ps were reported in G. K. Hubler, H. W. Kugel and D. E. Murnick, “Magnetic Moment of the 1.409 MeV 2⁺ State of ⁵⁴Fe”, Phys. Rev. Let. 29, 662 (1972), which is incorporated herein by reference in the entirety.

It is reasonable to assume that the hyperfine field is modulated by the disturbance of phonon excitations and electronic excitations that distort the s electron orbits at frequencies of 10¹³ to 10¹⁵ Hz, respectively. This frequency is then impressed upon the CEP term that produces a modulation of the magnetic hyperfine field at the nucleus. Since the motion of electrons locally causes the field, there is no inductive limit to achieving high frequency magnetic fields. Interstitial diffusion of hydrogen, shock, pulsed current, plasmons, magnetic pulses, etc., will also disturb the conduction electrons and this disturbance will appear as a fast modulation of the hyperfine field.

Hyperfine magnetic fields are present in a significant volume surrounding the nucleus, are not static at short time scales, and can be modulated at high frequencies by electron and phonon resonances.

### IV. Scalar Particles

It is noted herein that the Standard Model, Supersymmetric models and String Theory predict the existence of scalar particles. One such particle is the axion. The axion scalar particle is predicted by the Standard Model and is a strong candidate for a dark matter particle. Axions are generally discussed in Axions: Theory, Cosmology, and Experimental Searches, Eds., M. Custer, G. Raffelt, B. Beltrán (Springer, 2008), which is incorporated herein by reference in the entirety. It is noted that there are no previous experiments to directly search for dark matter candidate axion-like particles (ALP's) above the mass of 30 μeV due to experimental limitations of RF cavity searches. Constraints from stellar evolution and cosmology estimate the axion mass to be in the range of 1-100 μeV/c2 and De Broglie wavelengths of 1-10 m. As a result, cavity searches use cavity dimensions on the order of 1 m. It is noted, however, that an axion mass up to 1 eV has not been excluded. The properties of and the search for axions are generally discussed in L. J. Rosenberg, “Searching for the Axion”, SLAC Summer Institute on Particle Physics (SSI04), Aug. 2-13, 2004; G. G. Raffelt, “Axions—motivation, limits and searches”, J. Phys. A: Math. Theor. 40 (2007) 6607-6620; and S. J. Asztalos, L. J Rosenberg, K. van Bibber, P. Sikivie, and K. Zioutas, “Searches for astrophysical and cosmological axions”, Annu. Rev. Nucl. Part. Sci. 2006. 56:293-326, which are each incorporated herein by reference in the entirety.

In the forgoing description of solid-state resonance enhancement of hyperfine magnetic fields, the thickness of the solids in question is between 100 μm and 1 cm. In order to couple the axion/ALP field with the magnetic field, the De Broglie wavelength must be on the order of these dimensions. As a result, the mass energy of detectable axion/ALPs associated with embodiments of this disclosure is on the order of 1 meV to approximately 2 eV. For the purposes of the remainder of this disclosure the terms “axion” and “axion-like particles (ALP)” are generally used interchangeably.

Most direct cosmological axion searches rely on the inverse Primakoff process. The inverse Primakoff process converts an axion into a photon in an electromagnetic field. The interaction Lagrangian is:

L=g_{Agg}AE·B Eq. 3

where g_{Agg} is the coupling constant to an electromagnetic field, which is estimated to be less than <2.3 10⁻⁹ GeV⁻¹), A is the axion density, and E and B are the electric field and magnetic field of virtual photons respectively.

It is noted that there are two possibilities for experimental coupling to axions with electromagnetic fields:

1) L=g_{Agg}AE·B (DC magnetic field) Eq. 4a

2) L=g_{Agg}AE·(B₀+B_{M}exp(−iωt)) (oscillating magnetic field) Eq. 4b

where B₀ is the normal field in metallic palladium (˜60 T), B_{M} is the modulation amplitude (˜8000 T for Pd) and ω is the modulation frequency. It is noted that the field is always positive. It is further noted that the DC approach of Eq. 4a is used in experimental searches for axions and the oscillating field approach of Eq. 4b is the approach disclosed herein.

Eq. 5 is an expression for the expected power increase in a RF cavity search for an axion mass of 3 μeV where an RF cavity is placed inside a superconducting magnet with uniform field of 7.6 T. In this example, the RF cavity resonant frequency is swept over a range of frequencies and, in the event the frequency equals the axion mass frequency, Eq. 5 describes the increase in power in the cavity due to trapping of the converted photons. Eq. 5 can be used to estimate the power expected in a resonating crystal and states:

$$Resonant Conversion \text{:} hv = {m}_{a} {c}^{2} [ 1 + O ( {β}^{2} ) ] \\ {P}_{sig} ∼ ( 5 \times {10}^{- 22} W ) \cdot {( \frac{B}{7.6 T} )}^{2} \cdot ( \frac{V}{220 𝓁} ) \cdot {( \frac{{g}_{γ}}{0.97} )}^{2} \cdot ( \frac{{ρ}_{a}}{0.45 GeV \text{/} {cm}^{3}} ) \cdot ( \frac{{m}_{a}}{3 µ eV} ) \qquad Eq . 5$$

where B is the uniform magnetic field, V is the volume of the cavity, Gγ is a model dependent parameter close to 1.0, ρₐ is the axion galactic halo density, and mₐ is the axion mass.

For example, if it is assumed that a crystal has a static field B=76 T in line with the fields shown in Table 1, then the power estimate in Eq. 5 is increased by a factor of 100. The volume factor in the above expression is mass dependent. For instance, if an ALP mass is 100 meV then the equivalent cavity volume is 12×12×12 μm. Approximately 1×10̂8 cavities fit into a 0.1 mm×1 cm×1 cm volume crystal. For a fill factor of 10%, the volume factor is approximately 1, nearly the same as a single cavity search. The Primakoff coupling constant increases linearly with axion mass (last term in Eq. 5). For example, for an axion mass of 100 meV, this provides a power increase of 3.3×10̂4. It is noted that Eq. 5 is an on-resonance expression where the resonant term is incorporated into the prefactor. The resonant term is on the order of 1×10̂6 and is the smaller of the RF cavity Q or the resonant width of the axion due to axion velocity dispersion. The resonance term indicates a high probability for capturing the photon in the cavity, where in the case of the embodiments of the present disclosure the probability of capturing the photon is 1 since the crystal will absorb all photons created in it more than a skin depth beneath the surface. Multiplying these two factors, the increase in power is approximately 3.3×10̂6 for the galactic halo axion density. The predicted power then becomes approximately 1.7×10-15 watts.

### V. Colossal Magnetic Hyperfine Field in PdDx

It is noted that resonating phonons in crystalline material will cause motion of the electrons through the electron-phonon interaction and alternating current of the electrons at the phonon frequency can induce phonon oscillations through the electron-phonon interaction. The oscillatory motion of the electrons and/or the phonons will radiate photons at the frequency of the electron/phonon vibrations. This effect is the origin of thermal radiation characterized as Black Body radiation. However, in this case very specific frequency photons are emitted commensurate with the natural phonon frequencies of the material. It has been shown that this is possible in other materials—stimulated semiconductor single crystals can resonate coherently under a driving force. It is noted that if the stimulation is directional, phonons in specific directions in k-space will be preferred so that the photons created are also primarily emitted in a unique direction in the crystal. Driven phonon resonance and direction stimulation are described in T. Dekorsy, H. Auer, C. Wasehke, H. J. Bakker, H. G. Roskos, H. Kurz, V. Wagner and P. Grosse, “Emission of submillimeter electromagnetic waves by coherent phonons”, Phys. Rev. Lett. 74 (1995) 738; and M. Tani, R. Fukasawa, H. Abe, S. Matsuura, K. Sakai, and S. Nakashima, “Terahertz radiation from coherent phonons excited in semiconductors”, J. Applied Phys., 83, 2473 (1998), which are each incorporated herein by reference in the entirety. This mechanism can establish a directional flux of photons within the crystal. The relaxation time for the phonons is on the order of a picosecond (Q ˜600), so there is substantial photon flux existing at all times in a driven system. This is a necessary aspect of the inverse Primakoff conversion process where the preexisting photons provide the conditions for momentum conservation for resonant conversion. The imaging of nonequilibrium atomic vibrations is described in M. Trigo, J. Chen, V. H. Vishwanath, Y. M. Sheu, T. Graber and R. Henning and D. A. Reis, “Imaging nonequilibrium atomic vibrations with x-ray diffuse scattering”, Phys. Rev. B 82, 235205 (2010), which is incorporated herein by reference in the entirety.

An overvoltage increase during excess heat events is observed in PdH cathodes during electrolysis. The electrolysis is run in the constant current mode and a voltage increase (from 10 to 50%) indicates that the cell resistance has increased. The electrolyte resistance is several ohms and the PdDx cathode is 10 milliohms. It is assumed that the cathode resistance is increased by a factor of approximately 100. The voltage increase and the facts that there is substantial high frequency RF emission during excess heat events and magnetic impurities are known to facilitate the AHE leads to an understanding of the mechanism as discussed below.

It is submitted that a palladium crystal loaded with deuterium may be forced into coherent resonance by outside stimulation (e.g., charge exchange on the surface, acoustic shock, RF radiation, pulsed electric current, laser impingement, etc.). The triggering of the resonance may be facilitated by a morphology containing micro-features that develop on the surface of the cathode. Deuterium-loaded palladium cathodes were invested in V. Violante, E. Castagna, S. Lecci, F. Sarto, M. Sansovini, A. Torre, A. LaGatta, R. Duncan, G. K. Hubler, A. El-Boher, O. Azizi, D. Pease, D. Knies and M. McKubre, “Review of materials science for studying the Fleishmann-Pons Effect”, Cur. Sci. 108 (2015) 540, which is incorporated previously herein by reference in the entirety. The <100> textured grains result in phonons being pumped into the crystals and propagating in a restricted direction in k-space, momentarily causing an electronic phase transition to an insulating or semi-insulating state. This oscillation between metallic and insulating states at a frequency of approximately 10¹³ Hz produces the voltage increase in the current controlled electrolysis circuit by increasing the cathode impedance by approximately 2 orders of magnitude. An RF driven metal insulator transition has been seen, for example, in VO₂ as reported in M. Liu, H. Y. Hwang, H. Tao, A. C. Strikwerda, K. Fan, G. R. Keiser, A. J. Stembach, K. G. West, S. Kittiwatanakul, J. Lu, S. A. Wolf, F. G. Omeneto, X. Zhang, K. A. Nelson and R. D Averitt. “Terahertz field-induced insulator-to-metal transition in vanadium dioxide metamaterial”, Nature 487 (2012) 34, which is incorporated herein by reference in the entirety.

In the momentary insulating state, a palladium 5s electron becomes localized and unpaired on the palladium atom which produces a 15,890 T magnetic field impulse on the palladium nuclei (67,000 T for a 6s Pt electron). Transient magnetic fields are discussed in N. Benczer-Koller and G. J. Kumbartzki, “Magnetic moments of short-lived excited nuclear states: measurements and challenges,” J. Phys. G: Nucl. Part. Phys. 34 (2007) R321, which is incorporated previously herein by reference in the entirety; and N. Rud and K. Dybdal, “The transient magnetic field acting on swift nuclei moving in magnetized solids”, Physica Scripta 34, 561 (1986), which is incorporated herein by reference in the entirety. The instability in the electronic structure produces the cathode voltage increase and the high frequency RF emissions that are experimentally observed and large, coherent magnetic field impulses at the nuclei and in the atom. Table II shows the magnetic field for unpaired s electrons in several elements of interest.

TABLE II
Magnetic field available for unpaired s electrons in elements of interest

| Element | Z | Field (T) | Electron configuration | Comments |
|---|---|---|---|---|
| Pt | 78 | 67,175 | [Xe] 6s¹ 4f¹⁴ 5d⁹ | Anode |
| Pd | 46 | 15,890 | [Kr] 5s⁰ 4d¹⁰ | Cathode |
| Ni | 28 | 6,096 | [Ar] 4s² 3d⁸ | Cathode |
| Li | 2 | 56 | 1s² 2s¹ | electrolyte |
| D | 1 | 17 | 1s¹ | electrolyte |

It is noted that platinum (Pt) is included in Table II because of the fact that, in an electrolysis device with a Pt anode and PdDx cathode, Pt is transported from the Pt anode to the Pd cathode during electrolysis. The electronic phase transition is the key that provides efficient conversion of axions/ALPs to photons via the inverse Primakoff effect in PdDx. In addition, given that NiHx has an electronic band structure similar to PdDx, in NiHₓ systems that may feature a similar instability (6000 T field), an axion-photon conversion via the inverse Primakoff occur, which explains the existence of anomalous heat generated in NiHx.

If we use the approximately 16,000 T field, discussed above, associated with palladium in Eq. 5 to replace the 76 T value, the corresponding factor becomes 4.4×10̂6 yielding a total enhancement of 1.5×10̂11 and power conversion of 7.5×10̂−11 watts.

It is further noted that the Lagrangian in Eq. 3 can also be used to determine the possibility of an axion be converted by large solid-state static or dynamic electric fields coupled to the virtual electromagnetic B field. For example, the crystals BaTiO₃ and SrTiO₃, display very large crystal electric fields when modulated by a crystal resonance. The conversion by large electric fields is completely analogous with magnetic field conversion so the concepts discussed previously herein with respect to magnetic field conversion should be interpreted to extend to the case of conversion using dynamic electric crystal fields.

### VI. Dark Matter Energy Density in the Solar System

As discussed previously herein, solid-state conversion of axions into photons is the source of anomalous heat in PdD and like systems during electrolysis. It is noted that the dark matter density at Earth supports this conclusion. First, the relative velocity between the Earth and the dark matter 5^{th} caustic ring flow (i.e., “big flow”) is 265 km/s average and is maximum in mid-October (approximately 280 km/s) and minimum in mid-April (approximately 240 km/s) as noted in F. S. Ling P. Sikivie and S. Wick, “Diurnal and annual modulation of cold dark matter signals”, PHYS. Rev. D 70, 123503 (2004), which is incorporated herein by reference in the entirety. The local dark matter halo density in the 5^{th} caustic ring is predicted to be between 0.15×10⁻²⁴ and 1.7×10⁻²⁴ g/cm³. Using the average velocity of 265 km/s, the amount of mass that passes through a 1 cm² area perpendicular to the axion flow per second is 40 to 450×10⁻¹⁷ g/cm². Converting these masses to energy we have 0.36 to 4.1 mJ/cm²/s or 0.36 to 4.1 mW/cm². This is the expected power available for the predicted galactic halo dark matter density. Second, there are published calculations that suggest that the dark matter density is 10⁵-10⁷ greater in the solar system than in the galactic halo. The dark matter density in the solar system is discussed in A. Ananthaswamy, “GPS satellites suggest Earth is heavy with dark matter,” Cosmology, 2 Jan. 2014; N. P. Pitjev and E. V. Pitjeva, “Constraints on dark matter in the solar system”, Astronomy Letters, 39, (2013) 141; and S. L. Adler, “Solar system dark matter”, arXiv:0903.4879v1 [astro-ph.EP] 27 Mar. 2009, which are each incorporated herein by reference in the entirety. These estimates are derived from the belief that unexplained non-Newtonian orbits of planets, earth satellites and moons in the solar system and from anomalies in trajectories of satellite flybys are caused by the presence of trapped dark matter. Assuming an axion density of 2×10̂5 GeV/c², due to axion trapping in the solar system (see, e.g., Adler et al.) and the relative velocity between trapped axions and the Earth's velocity around the sun (30 km/s), the potential power available if 100% of the axions were converted to photons is approximately 40 Watts/cm². Third, it has been suggested that the halo axion flux might become temporally enormously enhanced due to gravitational lensing as discussed in K. Zioutas, V. Anastassopoulos, S. Bertolucci, G. Cantatore, S. A. Cetin, H. Fischer, W. Funk, A. Gardikiotis, D. H. H. Hoffmann, S. Hofmann, M. Karuza, M. Maroudas, Y. K. Semertzidis, I. Tkatchev, “Search for axions in streaming dark matter,” cited by Cornell University Library as arXiv:1703.01436 [physics.ins-det]. The gravitational lensing effect can occur if the Sun, a planet or other orbital body, such as the Moon, is found along the direction of a dark matter stream propagating towards the Earth's location. The flux increase associated with gravitational lensing could be as much as 1×10̂5 greater than the halo average and may last for several days.

The above estimates indicate that provided the probability axion conversion is significant, then there is adequate energy available in the conversion process to account for the observed anomalous heat effect in systems such as PdD. It is further noted that by increasing the dark matter density in Eq. 5 by 2×10̂5 provides a total enhancement of 3×10̂16 or a power enhancement estimate of approximately 2×10̂−5 Watts or approximately 0.02 mW/cm².

The full Lagragian for the interaction of axions with photons is provided by:

$$ℒ = \frac{1}{2} ( ε {E}^{2} - {B}^{2} ) + \frac{1}{2} {\partial }_{μ} a {\partial }^{μ} a - \frac{1}{2} {m}_{a}^{2} {a}^{2} - {g}_{γ} \frac{α}{4 π} \frac{a}{{f}_{a}} E \cdot B \qquad Eq . 6$$

where ∈ is the dielectric constant of the medium, a is the axion field, E is the electric field, B is a constant B field and fₐ and g_{γ} define the coupling constant. In the case of this disclosure, the magnetic field B is taken from Eq. 4b. Since the oscillation comprises the turning on and off of an electronic phase transition, the oscillatory B field may also be described by the square wave:

B=B₀ (1/2 cycle)

B=B₀+2B_{M} (2/2 cycle) Eq. 7

where a cycle period is approximately 10⁻¹³ s. Calculations for a formal derivation of the expected power conversion by oscillating magnetic fields from Eq.6 yield up to 3 orders of magnitude enhancement of the conversion probability, which adjusts the estimate for expected power into the 20 mW/cm² range. The above Lagragian is discussed in Axions: Theory, Cosmology, and Experimental Searches, Eds., M. Custer, G. Raffelt, B. Beltrán (Springer, 2008), which is incorporated previously herein by reference in the entirety; and P. Arias, A. Arza and J. Gamboa, “Mixing of photons with light pseudoscalars in time-dependent magnetic fields”, Eur. Phys. J. C (2016) 76:622, which is incorporated herein by reference in the entirety. The power estimate of 20 mW/cm² is sufficient to produce the magnitude of excess heat that is experimentally observed. It is noted that Pd cathodes consisting of foils from 4-20 cm² area up to 1 mm thick, and Pd rods up to 1 cm in diameter have produced excess heat. It is further noted that, in the case of a foil shaped cathode, the area of the foil will increase the power of converted photons and the volume factor in Eq. 5 will increase the total number of conversions.

It is noted herein that during the approximately 1×10̂−13 s that PdD is in an insulating state and the magnetic field is present, photons traveling at near the speed of light will cover a distance of approximately 30 μm. For a 100 μm thick cathode, those photons converted within 30 μm of the surface will emerge into the electrolyte but will then be absorbed by the electrolyte within a distance of approximately 1 mm. Those photons created less than 30 μm from the surface will be absorbed in the Pd lattice during the metallic phase of the system. Therefore, once an axion is converted to a photon, the probability of capture is 100%, and the heat generated via the absorption of the photons will appear to originate from the cathode.

### VII. Merging of Anomalous Heat Effect (AHE) Data with Cosmology

It is noted that the atoms in the Pd cathode and Pt additions in the cathode (due to the transport from the Pt anode to the Pd cathode) experience colossal magnetic field impulses from the electronic instability driven by the electrolysis current, where the electronic instability can be triggered by external pulsed energy sources. FIGS. 1B-1D data from various sources depicting the trigger mechanism described herein. For example, FIG. 1B illustrates a graph 110 showing power as a function of time in a PdD cathode, where the dotted line indicates the power emitted by the cathode, while the solid line indicates the absorbed power (provided by Naval Research Laboratory). FIG. 1C illustrates a graph 120 showing power as a function of time in a PdD cathode, where the dotted line indicates the power emitted by the cathode, while the solid line indicates the absorbed power (provided by ENEA, Frascata, Italy). FIG. 1D illustrates a graph 130 showing excess power as a function of time in a PdD cathode (provided by the University of Missouri—Columbia). The observation of excess power in PdD cathodes is discussed in V. Violante, E. Castagna, S. Lecci, F. Sarto, M. Sansovini, A. Torre, A. LaGatta, R. Duncan, G. K. Hubler, A. El-Boher, O. Azizi, D. Pease, D. Knies and M. McKubre, “Review of materials science for studying the Fleishmann-Pons Effect”, Cur. Sci. 108 (2015) 540; 0. Azizi, A. El-Boher, J. H. He, G. K. Hubler, D. Pease, W. Isaacson, V. Violante and S. Gangopadhyay, “Progress towards understanding anomalous heat effect in metal deuterides”, Cur. Sci., 108 (2015) 565, which are incorporated previously herein by reference in the entirety; and D. A. Kidwell, D. Dominguez, K. S. Grabowski, L. F. DeChiaro Jr., “Observation of radio frequency emissions from electrochemical loading experiments”; Current Science 108 (4)(2015) 578; and V. Violante, E. Castagna, S. Lecci, G. Pagano, M. Sansovini, F. Sarto. “RF detection and anomalous heat production during electrochemical loading of deuterium in palladium”; DOI 10.12910/EAI2014-62, which are each incorporated herein by reference in the entirety.

FIG. 1E illustrates optical phonon energies versus hydrogen or deuterium loading fraction in Pd obtained using neutron scattering. The large separation in phonon energy between H and D, and the large drop in the phonon energy above D/Pd fraction of 0.9 are noted herein. If it is assumed that an ALP has a mass of 35 meV, that corresponds to D/Pd fraction of 0.95. As the Pd loads with H or D in the electrolytic cell, the D/Pd fraction increases to 0.9. At this stage, there is no excess heat even if the cathode is in a resonance condition. As the D/Pd ratio approaches 0.95, and the cathode is in resonance, excess heat is observed. However, as the cathode heats up, it de-loads due to a decrease in the solubility of D as the temperature is increased, so that the D/Pd fraction drops below 0.95 and the excess heat stops. After the cathode cools down, it reloads, reaching D/Pd=0.95, coinciding with the resonant axion mass. Excess heat is also observed. This process then repeats itself. This mechanism explains heat bursts as observed in FIGS. 1B-1D. Based on FIG. 1E, it is clear that PdH will not likely produce excess heat for an ALP with a mass of 35 meV since the PdH phonon frequency always lies above 35 meV. It also suggests that the D/Pd ratio must be >0.88 in this example. Optical phonon energies in PdHx and PdDx are described in B. M. Geerkin, R. Griessen, L. M. Huisman and E. Walker, “Contribution of optical phonons the elastic moduli of PdHₓ and PdDₓ”, Phys. Rev. 26 (1982) 1637, which is incorporated herein by reference in the entirety.

It is noted herein that there exists a variety of additional factors that increase the probability of stimulating phonon resonance within a Pd cathode (or similar material). For example, each of the following factors may facilitate the stimulation of phonon resonance within a Pd cathode: 1) presence of a “Labyrinth” surface morphology of the Pd cathode surface increases the probability of resonance; and 2) implementation of an external trigger already mentioned including, but not limited to, acoustic pulse, laser pulse, electronic pulse through the cathode, electrolysis current modulation, cyclic stress, magnetic field—pulsed or DC, and RF stimulation.

It is further noted there exists a number of additional factors that may improve or maximize axion-photon conversion efficiency. Such factors include: 1) external magnetic field to polarize the PdDₓ atoms; 2) external magnetic field vector placed perpendicular to axion flow to maximize the inverse Primakoff effect; 3) orientation of the cathode to present the maximum surface area in the direction of axion flow (i.e., for foil, bar, plate or cathodes); and 4) inclusion of prominent crystallographic texture to the polycrystalline Pd cathode, with the texture direction parallel to the direction of the axion flow. For example, in the case of a Pd cathode, the <100> crystal direction being oriented parallel to the axion flow is preferred.

It is noted that the discussion above may be straightforwardly extended to crystals other than PdD, such as crystals brought into phonon resonance that coincidentally have the correct resonant frequency for efficient axion conversion. For example, ferrites, such as SrFe₁₂O₁₉ may undergo ferri-to-ferromagnetic oscillation and present a large magnetic field for scalar particle conversion. By way of another example, Au, Pd and Pt nanoparticles that become ferromagnetic at approximately 2-3 nm in size may display sufficient phonon resonance for efficient axion conversion. As shown in Table 1, Au has a 2000 T internal magnetic field. If ferromagnetic alignment is established in a significant volume of nanoparticles, the nanoparticle assembly can present this large magnetic field to the axion field, leading to the conversion of axions to photons. In turn, calorimetry may be used to form an axion detector. This configuration has an advantage in that the signal would be very constant and provide a useful device for point measurement of the axion energy density in the solar system. In this configuration, a 1×10̂12 enhancement in detection probability is maintained and the configuration will convert any arbitrary axion mass greater than approximately 1 meV. Properties of ferromagnetic nanoparticles are discussed in Y. Yamamoto and H. Hori, “Direct observation of the ferromagnetic spin polarization in Gold nanoparticles, A review”, Rev. Adv. Mat. Sci., 12 (2006) 23, which is incorporated herein by reference in the entirety.

Underlying mechanisms for the use of large crystal fields for axion detection are discussed in E. A. Paschos and K. Zioutas, “A proposal for axion detection via Bragg scattering”, Phys. Lett. B323 (1994) 36, which is incorporated herein by reference in the entirety.

### VIII. Discussion

In this section, the origin of the hyperfine magnetic field has been analyzed with a focus on how to harness the hyperfine field for axion/ALP detection and utilization. For the first time, it has been shown that the magnetic field occupies a significant volume of many crystals and is modulated on short time scales (10⁻¹³-10⁻¹⁵s) by phonon resonances and electron resonances through the electron-phonon interaction and conduction electron polarization (CEP). A resonating crystal can present to the axion/ALP field a large resonating magnetic field. If the resonant frequency matches the mass frequency of an axion/ALP, it resonantly converts into a photon through the inverse Primakoff effect.

Since the De Broglie wavelength must be on the order of the dimensions of the converting crystal, the various device embodiments discussed further herein may be suited for detecting ALPs having a mass greater than 1 meV, although this should not be interpreted as a limitation on the scope of the present disclosure. The expected signal strength is improved over searches in the μeV mass region by a factor of approximately 1×10̂4 in the coupling constant of ALPs to the electromagnetic field by colossal dynamic crystal magnetic fields of order of 10⁴ T (approximately a 1×10̂6 enhancement over ADMX), by 1×10̂5 greater axion density in the solar system and by 1×10̂3 enhancement in the conversion probability due to the fact that the magnetic field oscillates at the mass frequency of the ALP. PdDₓ, NiHx and other materials may be brought into resonance using electrochemical discharge current, pulsed lasers, high GHz to THz RF sources, short electric pulses, acoustic pulses and convert the axions/ALPs into photons and heat (which may be measured via IR spectroscopy and/or calorimetry). It is possible that other crystals carefully chosen for magnetic properties and phonon frequencies could provide for stable axion conversion, albeit with a lower (approximately 100-300 T) normal static hyperfine field) magnetic field enhancement. It is further noted that the fact that PdDₓ produces the excess heating effect and PdHₓ is much less pronounced is due to the matching of the PdDₓ phonon frequency to the scalar particle mass and the non-overlap of the PdHₓ phonon frequency to the scalar particle mass.

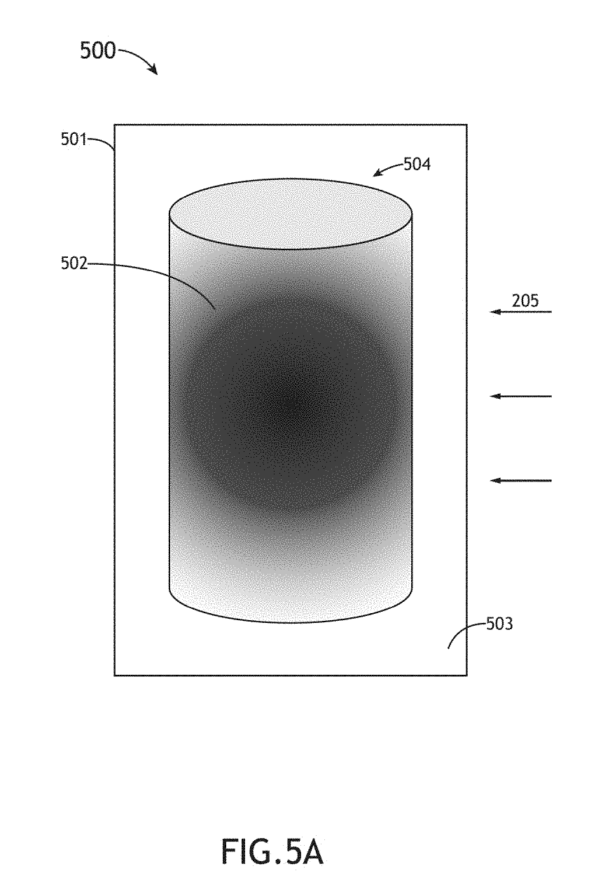

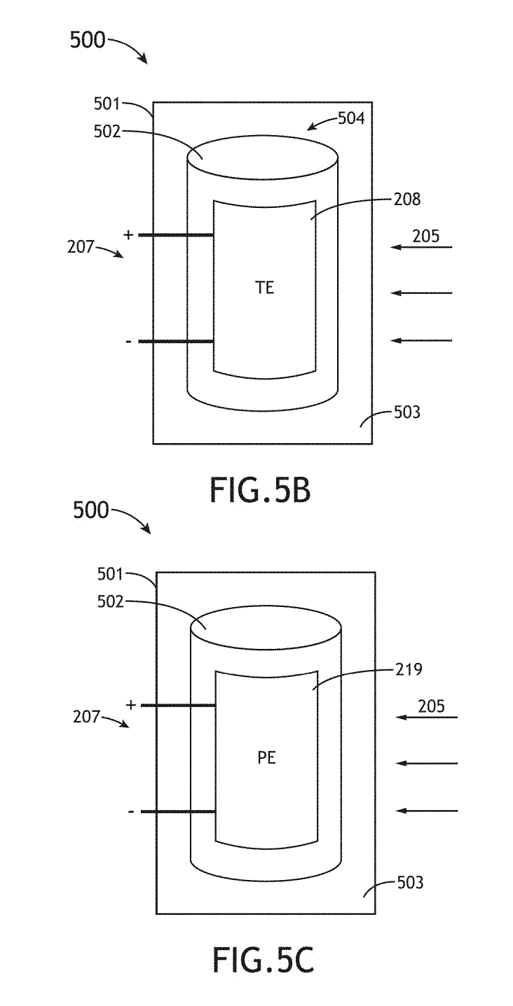

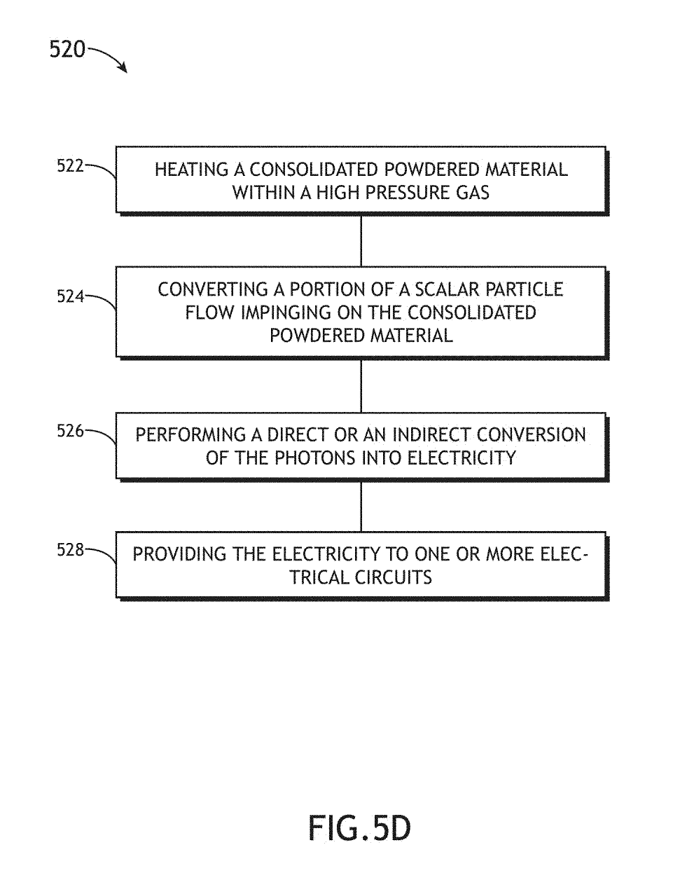

While a single axion mass is predicted by the Standard Model of Particle Physics, multiple masses are predicted in Supersymmetry and String theories. Based on FIG. 5A-C, there may exist more than one scalar particle mass. If continuing experiments reveal more than one photon energy, it would provide a window into physics beyond the standard model.

The remainder of this disclosure is focused on various device and method embodiments for carrying out the conversion of scalar particles to photons/heat via direct and indirect approaches.

### IX. Embodiments

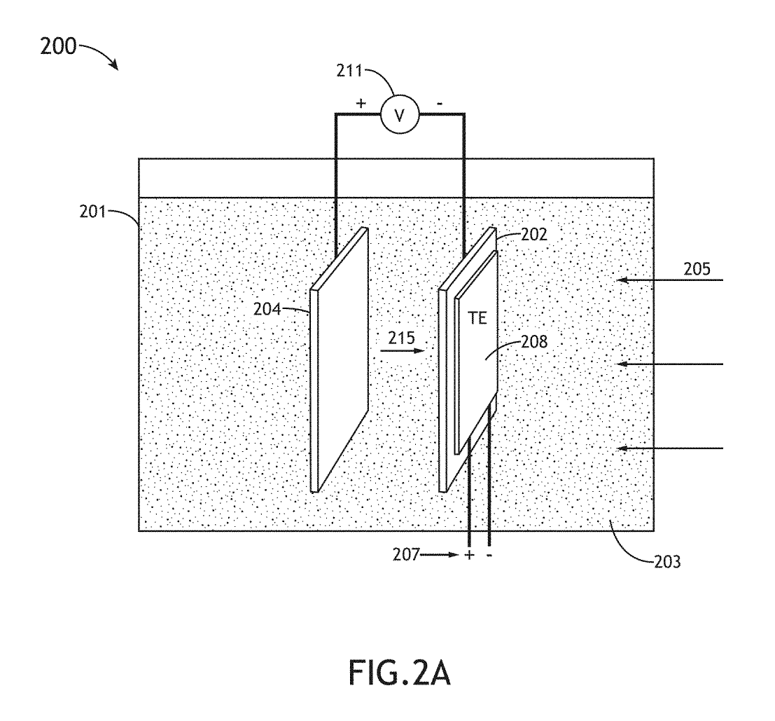

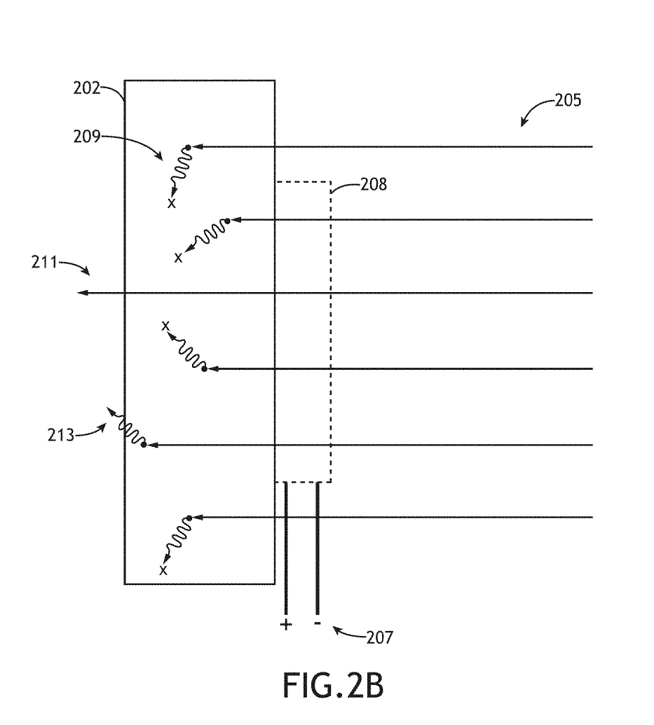

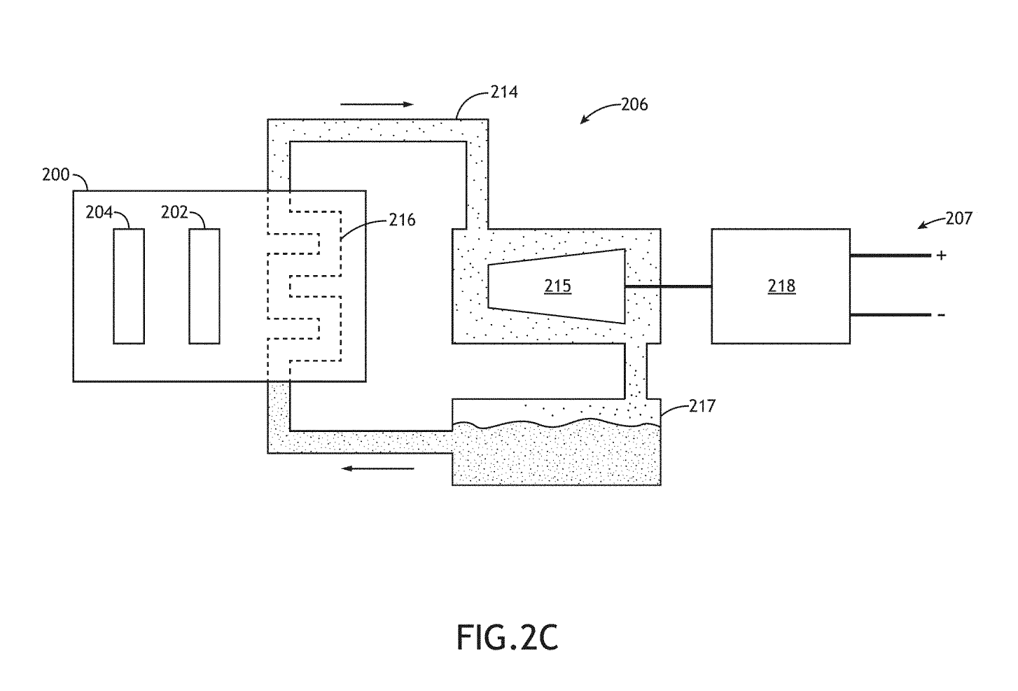

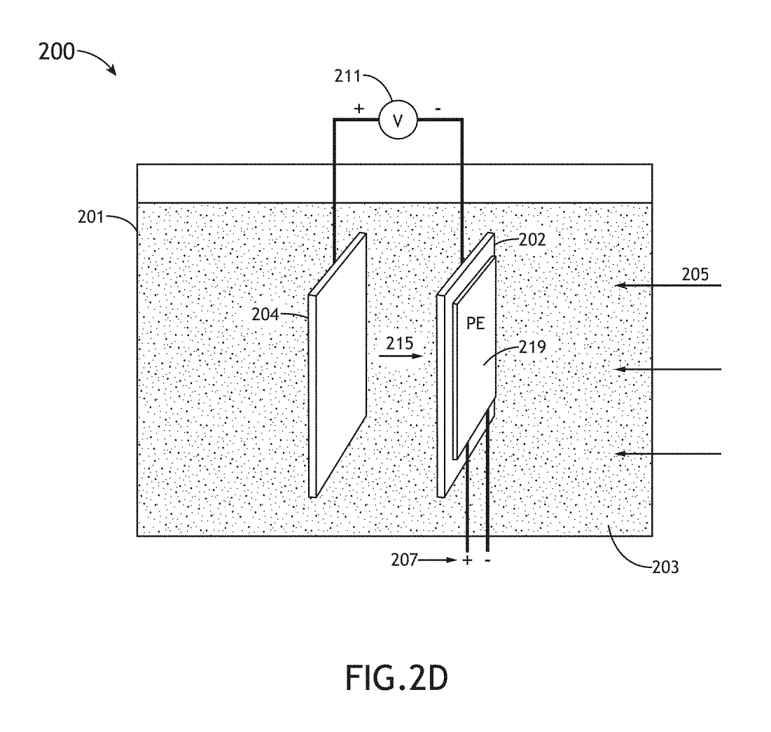

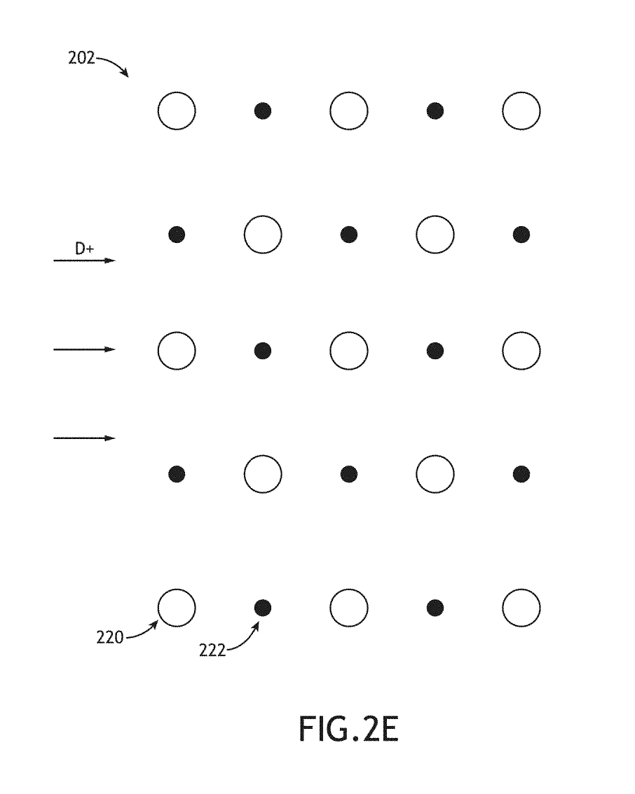

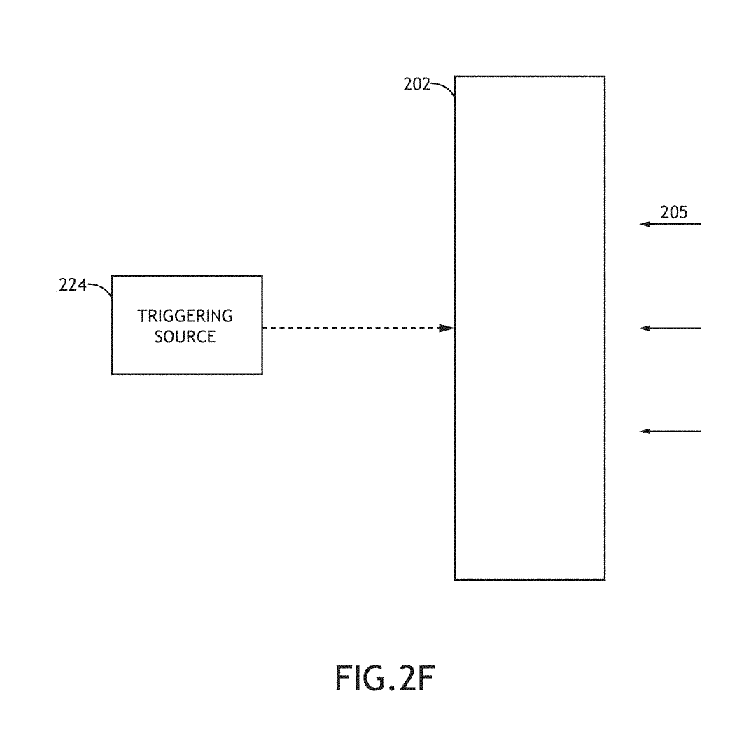

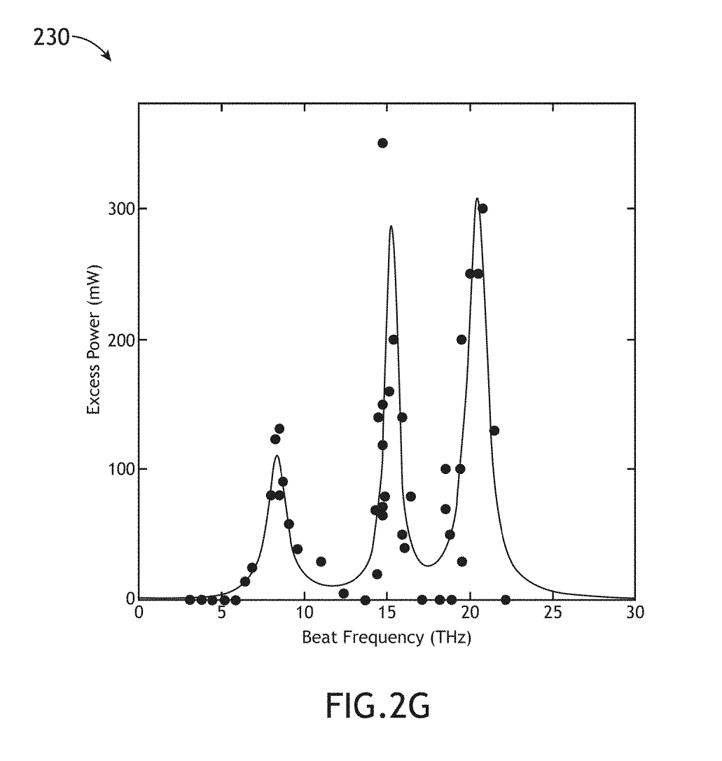

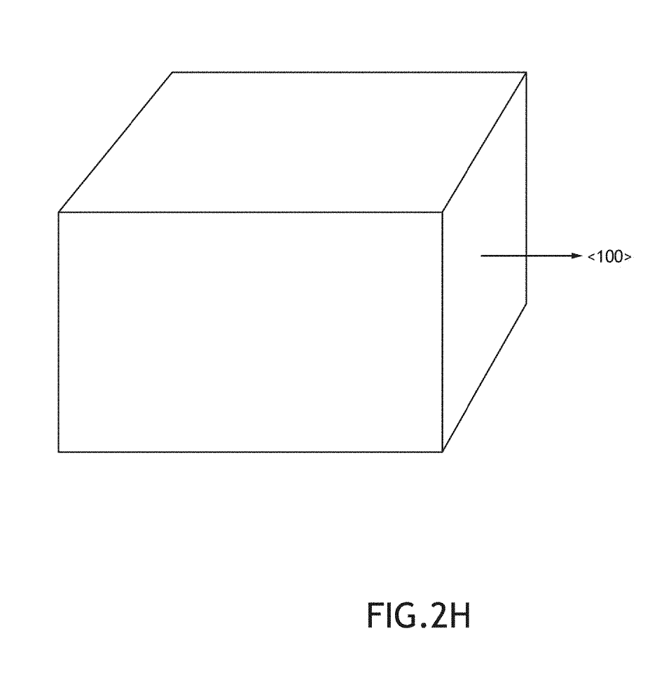

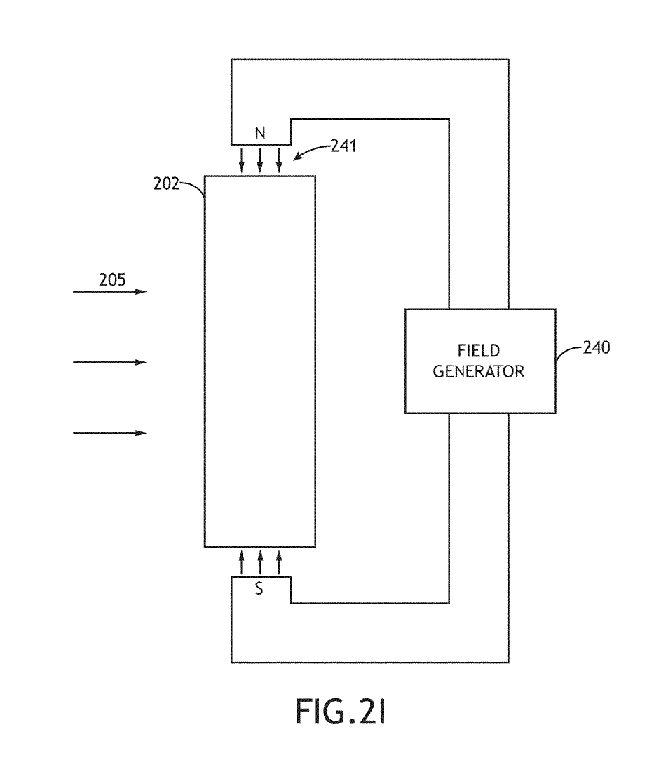

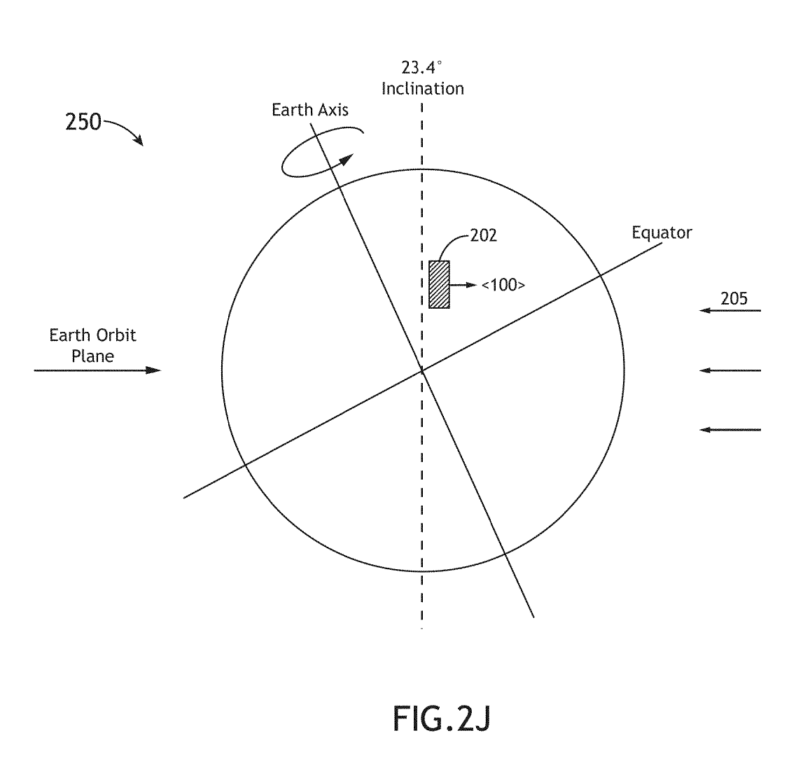

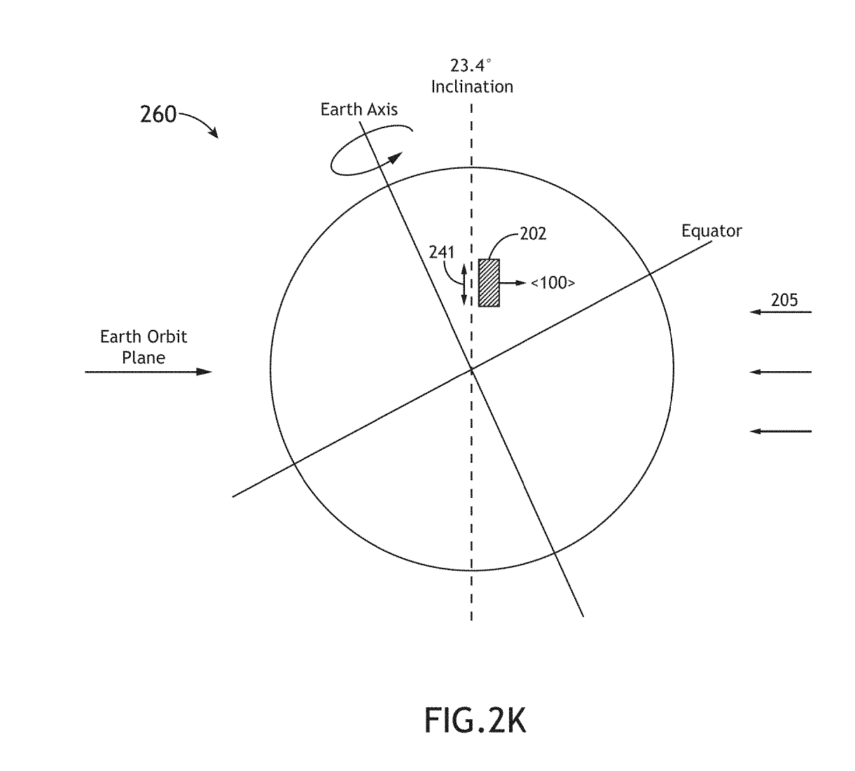

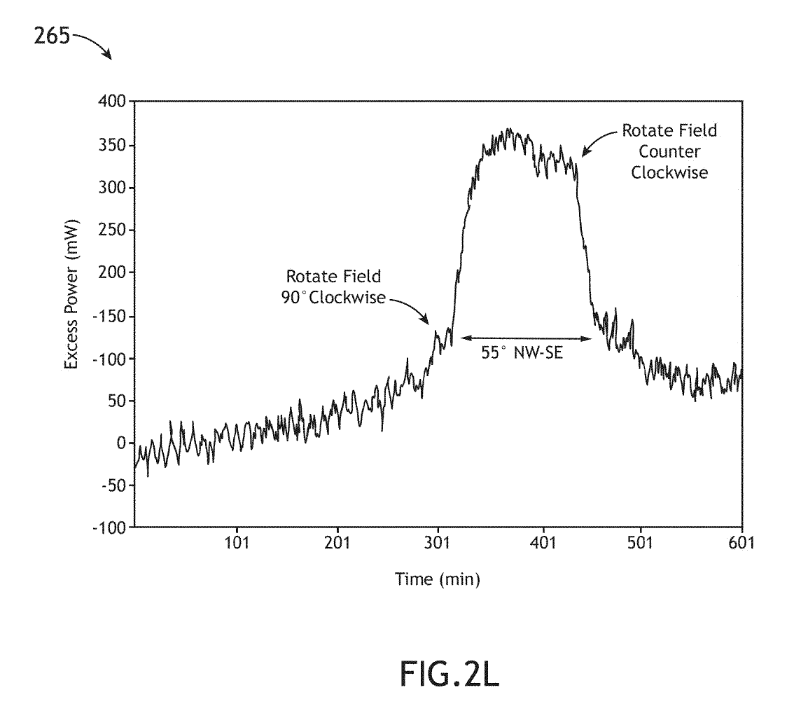

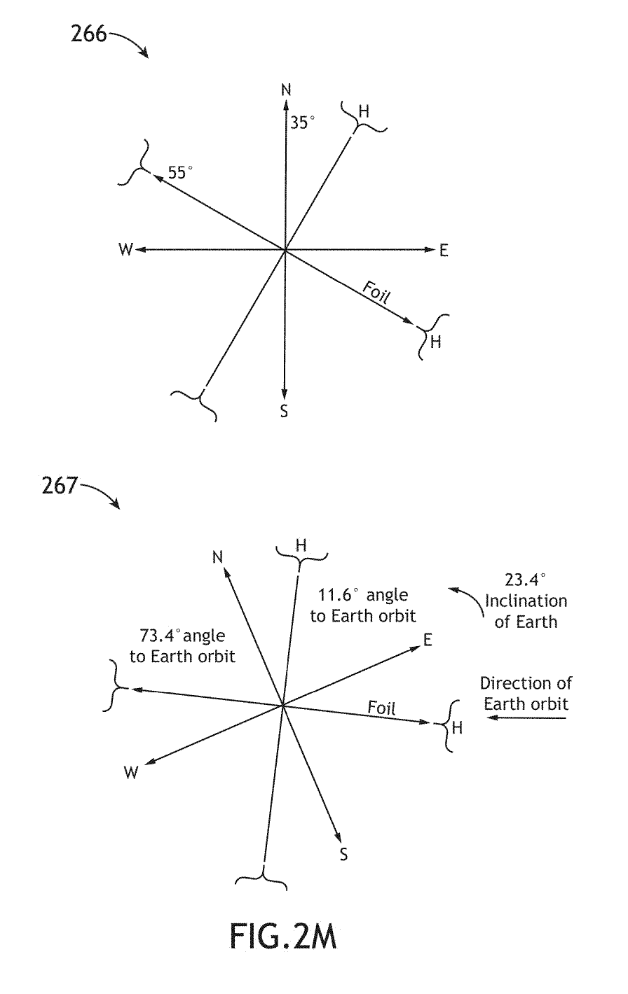

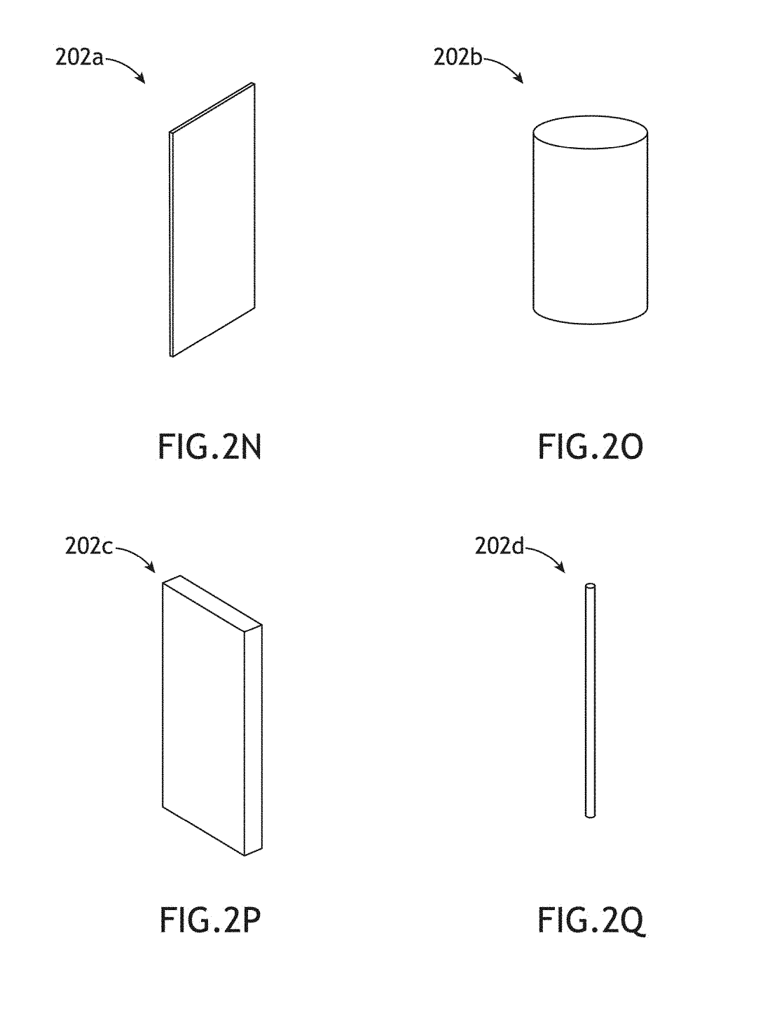

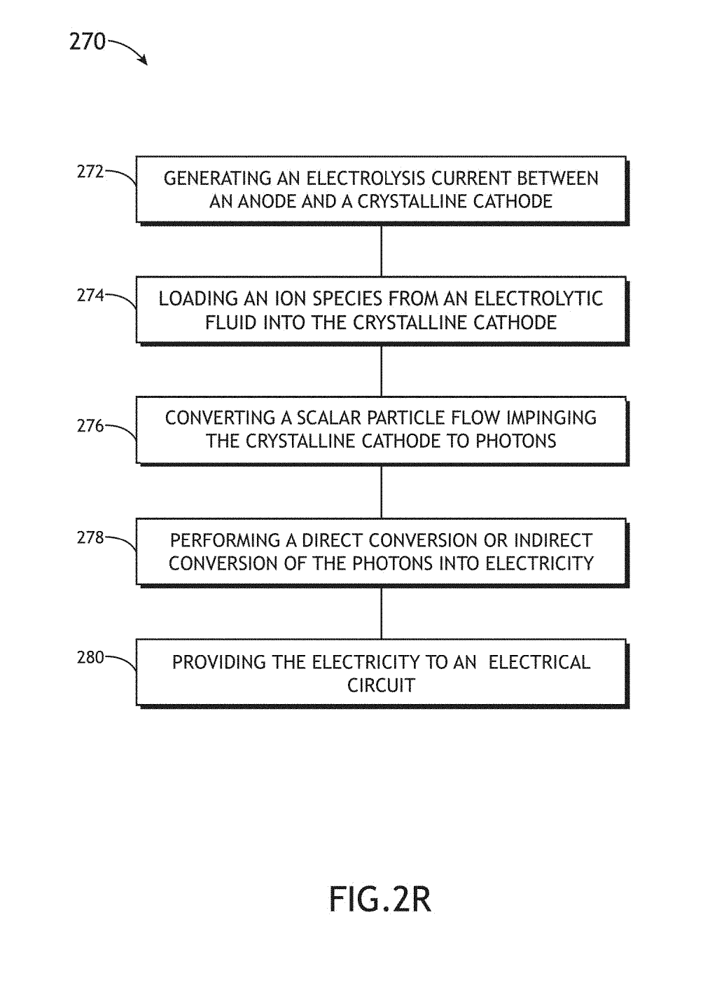

FIG. 2A illustrates a scalar particle conversion device 200, in accordance with one or more embodiments of the present disclosure. In one embodiment, the conversion device 200 includes a crystalline cathode 202 and an anode 204 disposed within an electrolytic fluid 203 contained in container 201. In another embodiment, a voltage source 211 is electrically coupled to the crystalline cathode 202 and anode 204 and configured to generate an electrolysis current 215 between the crystalline cathode 202 and anode 204. Further, one or more ion species from the electrolytic fluid 203 are loaded into the crystalline cathode 202 in order to establish and/or enhance the conversion of the scalar particle flow 205 via the inverse Primakoff effect into photons and, thus, heat in the crystalline cathode 202.

It is noted herein that oscillating magnetic hyperfine fields within the crystalline cathode 202 interact with the scalar particle flow 205 and converts some portion of the scalar particle flow 205 to photons via the inverse Primakoff effect. Further, a portion of the scalar particle flow 205 is converted to photons within the crystalline cathode 202 via resonance between the phonon frequency of the crystalline cathode 202 and the mass frequency of the scalar particles within the scalar particle flow.

The photons generated by the interaction between the oscillating magnetic hyperfine fields within the crystalline cathode 202 and the scalar particle flow 205 are absorbed by the crystalline cathode 202 leading to the generation of heat within the crystalline cathode 202. The heat generated in the crystalline cathode 202 is the origin of the anomalous heat effect.

As shown in FIG. 2B, a portion of the scalar particle flow 205 interacting with oscillating magnetic fields, such as the internal crystal fields, within the cathode 202, may be converted to photons 209 via the inverse Primakoff effect. In turn, heat may be generated in the material via the absorption of the photons 209. It is noted that some of the scalar particles 211 of the scalar particle flow 205 may pass through the crystalline cathode 202. In addition, some scalar particles of the particle flow 205 may lead to the production of photons 213 at or near a surface of the crystalline cathode 202, allowing the photons 213 to be emitted from the crystalline cathode 202.

The materials used in the crystalline cathode 202, anode 204 and electrolytic fluid 203 may be selected in order to enhance the heat generation via the inverse Primakoff effect, and, therefore, the electrical output 207 caused by the conversion of heat (resulting from absorbed photons from Primakoff effect) to electricity.

In one embodiment, the crystalline cathode 202 is arranged such that a scalar particle flow 205 impinges on the crystalline cathode 202 at a selected angle. It is noted that since scalar particles, such as axions, permeate the universe under the standard model the crystalline cathode 202 will almost always be impinged by some scalar particle flow 205. However, as discussed in greater detail further herein, the crystalline cathode 202 may be oriented so as to maximize the scalar particle flow 205 by presenting the maximum surface area of the cathode 202 to the scalar particle flow 205.

In another embodiment, the conversion device 200 includes one or more thermal conversion devices 208. The one or more thermal conversion devices 208 may be thermally coupled to one or more portions of the crystalline cathode and are configured to convert heat from the crystalline cathode 202 to an electrical output 207.

In one embodiment, as depicted in FIGS. 2A-2B, the one or more thermal conversion devices 208 include one or more thermoelectric (TE) conversion devices for converting heat generated via the inverse Primakoff effect within the crystalline cathode 202 to an electrical output 207. While a single TE device 208 is depicted in FIG. 2A, this depiction should not be interpreted as a limitation on the scope of the present disclosure and is provided merely for illustrative purposes. For instance, the one or more thermal conversion devices 208 may include a set of thermoelectric devices arranged in an array on one or more surfaces of the crystalline cathode 202. In another embodiment, although not shown, one or more intermediate heat conduits (e.g., heat conduction pipes) may be used to transfer heat from the crystalline cathode 202 to one or more thermal conversion devices 208. In another embodiment, although not shown, the one or more thermal conversion devices 208 may be directly thermally coupled to the electrolytic fluid 203 (e.g., heat transfer coil placed in electrolytic fluid 203), thereby indirectly receiving heat from the crystalline cathode 202 via the heat transfer through the electrolytic fluid 203. In another embodiment, although not shown, the one or more thermal conversion devices 208 may be thermally coupled to the container 201, thereby indirectly receiving heat from the crystalline cathode 202 via the heat transfer through the electrolytic fluid 203 and the container 201.

It is recognized that those of ordinary skill in the art, with the benefit of the present disclosure, may recognize a variety of equivalent configurations and embodiments for generating electricity via a thermoelectric device using the conversion device 200 as a heat source.

In another embodiment, as depicted in FIG. 2C, the one or more thermal conversion devices include one or more steam generator systems 206. In this example, the scalar particle conversion device 200 may be thermally coupled to a steam generator system 206 such that the thermal energy from the conversion device 200 acts to drive one or more turbines 215 of the steam generator system 206. In one embodiment, the steam generator system 206 may include any number of conversion devices 200. In this embodiment, the one or more conversion devices 200 serve as the heat source for the steam generator system 206. The heat generated by the one or more cathodes 202 of the one or more conversion device 200 may be transferred via a heat transfer loop 214 to turbine 215. In this example, heat may be transferred from the cathode 202 to a fluid medium, such as, but not limited to, water/steam, circulated within the heat transfer loop 214. In the case of water-based heat transfer loop, heat from the cathode 202 may be transferred to the heat transfer loop 214 via one or more heat transfer coils 216 or heat exchangers, where it heats water entering coil 216 and converts it to steam. The heated steam is then transferred to the turbine 215, where the energy in the steam acts to drive the turbine 215. The rotating turbine 215 then drives the electrical generator 218, thereby producing an electrical output 207. As the steam cools, it is circulated to the condenser 217, where the steam may further cool until it condenses to water. The water may then be returned to heat transfer coil 216 as the process repeats.

It is recognized that those of ordinary skill in the art, with the benefit of the present disclosure, may recognize a variety of equivalent configurations and embodiments for generating electricity via a steam generator using the conversion device 200 as a heat source.

In another embodiment, although not shown, the conversion device 200 may be used as a heat source in a heated water/steam distribution system. For example, heat from the cathode 202 of the conversion device 200 may be transferred to water contained in one or more pipes via a heat coil or heat exchanger. The heated water or steam may then be transported to a destination (e.g., commercial applications, hot water for residential use, etc.).

In another embodiment, as depicted in FIG. 2D, the conversion device 200 includes one or more photoelectric devices 219 arranged to receive photons 213 (not shown in FIG. 2D—see FIG. 2B) emitted from the crystalline cathode 202. It is noted again that the photons 213 emitted by the crystalline cathode 202 are generated by the inverse Primakoff effect through the interaction of the oscillating magnetic fields within the cathode 202. The one or more photoelectric devices 219 receive the photons 213 and directly convert the photons 213 to an electrical output 207. For example, the one or more photoelectric devices 219 may include one or more low band gap photovoltaic (PV) cells, such as, but not limited to, one or more semiconductor PV cells (e.g., silicon-based PV cell). By way of another example, the one or more photoelectric devices 219 may include one or more quantum cascade devices.

In one embodiment, the crystalline cathode 202 is formed from palladium (Pd) with the electrolytic fluid 203 including heavy water (D₂O). In another embodiment, the anode is formed from platinum (Pt). It is noted that Pt is known to be transported from the Pt anode to the Pd cathode during electrolysis. In this embodiment, deuterium from the heavy water solution loads the palladium cathode to form PdDx, where the loading ratio (x) is between 0.2 and 1. For example, x may be greater than about 0.3. For instance, as shown in FIG. 2E, deuterium ions (D+) from the heavy water solution 203 are attracted to the palladium cathode and then load the palladium cathode, where they occupy interstitial locations 222 of the palladium crystal lattice 220.

As noted previously herein, the Pd atoms in the cathode 202 and/or the Pt alloy additions in the cathode experience colossal magnetic field impulses from an electronic instability driven by the electrolysis current in the crystalline cathode 202.

In cases where a resonance condition between the crystalline cathode 202 and the mass frequency of the scalar particles of the scalar particle flow 205 can be achieved, the large oscillating magnetic fields within the crystal may convert the scalar particles to photons via the inverse Primakoff effect.

In another embodiment, as shown in FIG. 2F, one or more triggering sources 224 may be employed to drive the phonon frequency of the crystalline cathode 202 into resonance with the mass frequency of the scalar particles of the scalar particle flow 205. The one or more trigger sources 224 may impart any stimulation mechanism suitable for stimulating coherent resonance within the crystalline cathode 202, such as, but not limited to, charge exchange on the surface of the cathode 202, acoustic shock, RF pulses, pulsed electric current, laser pulses, magnetic field pulses and the like.

In another embodiment, the one or more triggering sources 224 include one or more external pulsed energy sources. For example, the one or more external pulsed energy sources may include, but are not limited to, one or more an acoustic generators (e.g., piezoelectric transducer) configured to impart pulsed sound waves via the electrolytic fluid 203 onto the crystalline cathode 202. By way of another example, the one or more external pulsed energy sources may include, but are not limited to, one or more RF generators configured to direct pulsed radio frequency radiation onto the crystalline cathode 202. FIG. 2G depicts the stimulation of heating within Pd during hydrolysis in lithium deuteroxde (LiOD) stimulated by the application of THz radiation as a function of frequency. The first two peaks correspond to PdD optical phonons. The peak at approximately 22 Hz is evidence of THz radiation stimulated optical phonon resonance responsible for converting ALPs with a mass of around 35 meV. By way of another example, the one or more external pulsed energy sources may include, but are not limited to, one or more lasers configured to direct pulsed laser light onto the crystalline cathode 202. By way of another example, the one or more external pulsed energy sources may include, but are not limited to, one or more electromagnetics configured to impart magnetic field pulses through the crystalline cathode 202. Alternatively, the one or more triggering sources 224 may include a magnetic for supply a static magnetic field to the cathode 202. By way of another example, the one or more triggering sources 224 may include a mechanical device (e.g., actuation device) for applying cyclical stress to the cathode 202.

In one embodiment, the one or more pulsed energy sources include the voltage source 208 and/or additional electrical circuitry coupled to the cathode 202. For example, the voltage source 211 and/or additional voltage circuitry may apply an electronic pulse through the cathode 202 to drive the phonon frequency of the crystalline cathode 202 into resonance with the mass frequency of the scalar particles. By way of another example, the voltage source 211 and/or additional voltage circuitry may modulate the electrolysis current passing through the cathode 202 to drive the phonon frequency of the crystalline cathode 202 into resonance with the mass frequency of the scalar particles.

The stimulation of optical phonons in deuterated palladium is described in D. Letts and P. Hagelstein, “Stimulation of optical phonons in deuterated palladium”, Proceedings ICCF14, Washington, D.C., 2008, p. 333, which is incorporated herein by reference in the entirety.

In another embodiment, one or more surfaces of the crystalline cathode 202 may be formed to have a labyrinth surface morphology. It is noted that the triggering of the resonance within the crystalline cathode 202 is enhanced via a surface morphology (i.e., the surface receiving pulsed energy) that contains micro-features that develop on the surface of the cathode. The presence, formation and impact of a microstructured surface morphology on Pd/D (and other metal deuterides) is discussed by V. Violante, E. Castagna, S. Lecci, F. Sarto, M. Sansovini, A. Torre, A. LaGatta, R. Duncan, G. K. Hubler, A. El-Boher, O. Azizi, D. Pease, D. Knies and M. McKubre, “Review of materials science for studying the Fleishmann-Pons Effect”, Cur. Sci. 108 (2015) 540; O. Azizi, A. El-Boher, J. H. He, G. K. Hubler, D. Pease, W. Isaacson, V. Violante and S. Gangopadhyay, “Progress towards understanding anomalous heat effect in metal deuterides”, Cur. Sci., 108 (2015) 565; and D. Knies, R. Cantwell, O. Dmitriyeva, S. Hamm, and M. McConnell, “Method to Control Palladium Crystallographic Texture and Surface Morphology”, Proceedings ICCF19, Padua, Italy, April 2015, which are each incorporated previously herein by reference in the entirety.

In another embodiment, the crystalline cathode 202 is crystallographically textured such that a selected crystal texture is selectively oriented with respect to the scalar particle flow 205. For example, the crystalline cathode 202 may be crystallographically textured such that a selected crystal texture is oriented parallel or perpendicular to the scalar particle flow 205. For instance, as shown in FIG. 2H, in the case of a palladium-based cathode, the palladium-based cathode may be arranged such that the <100> crystal direction of the palladium cathode is oriented parallel to the scalar particle flow 205. It is noted that textured grains within the crystalline cathode 202 may cause phonons to be pumped into the crystal(s) of the cathode such that they propagate in a restricted direction in k-space. If the stimulation from the one or more triggering sources 224 is directional, phonons in specific directions in k-space will be preferred so that the photons created are also primarily emitted in a unique direction in the crystal. This mechanism can establish a directional flux of photons within the crystal cathode 202. The relaxation time for the phonons is on the order of picoseconds, so there is substantial photon flux existing at all times in a driven system.

The textured grains (e.g., <100> texture) of the crystalline cathode 202 result in phonons being pumped into the crystals of the cathode 202 and propagating in a restricted direction in k-space, momentarily causing an electronic phase transition to an insulating or semi-insulating state. This oscillation between metallic and insulating states at a frequency of ˜10¹³ Hz produces the voltage increase in the current controlled electrolysis circuit by increasing the cathode impedance by approximately 2 orders of magnitude.

In another embodiment, as illustrated in FIG. 2I, an external magnetic field generator 240 is employed to polarize the atoms contained within the crystalline cathode 202. It is noted that polarizing the atoms within the crystalline cathode 202 enhances the magnitude of the internal magnetic field presented to the scalar particle flow 205 and, thus, enhances the scalar particle/photo conversion process of the inverse Primakoff effect. In one embodiment, an external magnetic field 241 may be applied by the external magnetic field generator 240 such that it is perpendicular to the scalar particle flow 205. For example, as shown in FIG. 2I, the external magnetic field 241 may be oriented perpendicularly to the scalar particle flow 205, whereby the magnetic field 241 is oriented along the lengthwise direct of the crystalline cathode 202 (up/down in FIG. 2G). Alternatively, the external magnetic field 241 may be applied perpendicularly to the scalar particle flow 205 by aligning the magnetic field in a direction perpendicular to the lengthwise direction of the cathode 202. In this example, such an orientation would correspond to in/out of the FIG. 2I illustration. In one embodiment, the magnitude of photon/heat production by the crystalline cathode 202 is proportional to the sine of an angle between a direction of the external magnetic field and the direction of the scalar particle flow.

FIG. 2J illustrates a conceptual view 250 of the compensation of the Earth's tilt when orientating the crystalline cathode 202, in accordance with one or more embodiments of the present disclosure. It is noted that under various models the flow of scalar particles, such as axions, will be larger in the solar system than in the galactic halo. The nature of dark matter and scalar particles in the solar system are discussed in A. Ananthaswamy, “GPS satellites suggest Earth is heavy with dark matter,” Cosmology, 2 Jan. 2014; N. P. Pitjev and E. V. Pitjeva, “Constraints on dark matter in the solar system”, Astronomy Letters, 39, (2013) 141; and S. L. Adler, “Solar system dark matter”, cited by Cornell University Library as arXiv:0903.4879v1 [astro-ph.EP] 27 Mar. 200935; and K. Zioutas, V. Anastassopoulos, S. Bertolucci, G. Cantatore, S. A. Cetin, H. Fischer, W. Funk, A. Gardikiotis, D. H. H. Hoffmann, S. Hofmann, M. Karuza, M. Maroudas, Y. K. Semertzidis, I. Tkatchev, “Search for axions in streaming dark matter,” cited by Cornell University Library as arXiv:1703.01436 [physics.ins-det], which are each incorporated by reference in their entirety previously herein.

In one embodiment, the crystalline cathode 202 is arranged so as to present the maximum surface area of the crystalline cathode 202 to the direction of the scalar particle flow 205. For example, the crystalline cathode 202 may be oriented such that the surface having the largest surface area is perpendicular to the scalar particle flow 205. In another embodiment, a magnitude of energy production by the crystalline cathode 202 is proportional to the cosine of an angle between a direction normal to the maximum surface area and a direction of the scalar particle flow.

In the case where the maximum scalar particle flow is approximately in the plane of the solar system (i.e., plane of Earth's orbit), this can be accomplished by compensating for the tilt of the Earth's axis relative to the plane of the solar system as shown in FIG. 2J. In another embodiment, the crystalline cathode 202 may be formed so that the largest surface area has a selected crystal texture. For example, the largest surface of the crystalline cathode 202 may have a <100> crystal texture. In addition, the surface may be oriented perpendicular to the Earth's orbital plane (thus perpendicular to the expected maximum scalar particle flow), leading to an enhancement of the inverse Primakoff effect.

In another embodiment, as shown in FIG. 2K, an external magnetic field 241 for polarizing the atoms of the crystalline cathode 202 may be applied while the orientation of the cathode 202 is corrected for the Earth's tilt. For example, the external magnetic field 241 may be oriented perpendicularly to the scalar particle flow 205, whereby the field 241 is oriented parallel to the largest surface of the cathode 202 (e.g., up/down in FIG. 2K or in/out of page (not shown)), It is noted that the largest surface of the cathode 202 is oriented so as to compensate for the 23.4 degree tilt of the Earth's axis.

FIG. 2L illustrates excess power data 265 measured as a function of time in a palladium foil cathode in a D₂O/LiOH electrolyte as an applied magnetic field is rotated through the cathode foil, in accordance with one or more embodiments of the present disclosure. The data provided in FIG. 2L was acquired by Dennis Letts and is reproduced herein with permission. FIG. 2M illustrates a conceptual view of the experimental layout used to acquire the excess power data 265 as a function of time as the magnetic field was rotated through the foil cathode in D₂O/LiOH. Configuration 266 depicts the orientation of the applied magnetic field at different times through data acquisition. At a first time, the field is oriented at parallel to the foil surface along a direction 55 degrees from north (in NW direction). The field is then rotated 90 degrees from the first position in a clockwise direction to 35 degrees from north (in NE direction). Configuration 267 depicts the correction for Earth's inclination to the Earth's orbital plane about the Sun. As in the configuration 267, the magnetic field was rotated 90 degrees to an orientation perpendicular to the surface of the foil (11.6 degree angle to Earth's orbit) and then returned to an orientation parallel with the foil (73.4 degree angle to Earth's orbit). As shown in FIG. 2L, the foil cathode began to display an uptick in excess power at approximately 301 seconds, which corresponds to the time the magnetic field was rotated to an orientation perpendicular to the surface of the foil. In turn, the excess power remained elevated (peak of approximately 320 mW after removing background) until the magnetic field was rotated to an orientation parallel to the surface of the foil. As previously noted, a magnitude of energy production by the crystalline cathode 202 is proportional to the cosine of an angle between a direction normal to the maximum surface area of the cathode and a direction of the scalar particle flow. The angle between the maximum surface area and the direction of scalar particle flow (if assumed the scalar particle flow is maximum in the plane of Earth's orbit) is 11.6 degrees when the cathode displayed peak excess heat and 73.4 degrees when displayed minimal excess heat. The ratio of these two quantities is representative of the relative change in thermal output between the two orientations and provides 3.3. In comparison, the ratio between the measured thermal output in the two states (˜320 mW at 11.6 degrees from Earth orbit and ˜70 mW at 73.4 degrees from Earth orbit) provides approximately 3.4. This result is consistent with the scalar product/dark matter model.

It is noted that the shape of the crystalline cathode 202 is not limited to the foil shape depicted in FIG. 2A, which is provided merely for illustration. Rather, the crystalline cathode 202 may take on any number of shapes. For example, as previously discussed and shown in FIG. 2N, the crystalline cathode 202a may take on a foil shape. By way of another example, as shown in FIG. 2O, the crystalline cathode 202b may take on cylindrical shape. By way of another example, as shown in FIG. 2P, the crystalline cathode 202c may take on a parallelepiped (e.g., plate) shape. By way of another example, as shown in FIG. 2Q, the crystalline cathode 202d may take on a wire or filamentary shape.

While much of the present disclosure is described in the context of palladium-based conversion devices, it is noted herein that the cathode 202, anode 204 and electrolytic fluid 203 are not limited to palladium, platinum and heavy water respectively. Rather, the materials of the conversion device 200 may be extended to any material combination that gives rise to the inverse Primakoff effect. In one embodiment, the crystalline cathode 202 may be formed from nickel (Ni) with the electrolytic fluid. In this embodiment, the hydrogen ions form the water may serve to load the Ni-based cathode to form NiHx. It is noted that NiHₓ possesses an electronic band structure similar to PdHx. As such, NiHₓ may feature a similar instability (e.g., 6000 T field). It is further noted that the various configurations (e.g., phonon resonance triggering mechanism(s), crystallographic texturing, surface morphology, cathode orientation, etc.) discussed with respect to PdDx may be extended to alternative materials systems such as, but not limited to, NiHx, where x is between 0.2 and 1. For example, x may be greater than about 0.3. Additional materials and material combinations are described in additional detail further herein.

In another embodiment, the electrical output 207 generated by the conversion device 200 may be coupled to one or more electrical circuits. In this regard, the conversion device 200 may serve as an electrical power source for any number and type of electrical devices. For example, the one or more electrical circuits may include or be embodied as an energy storage device (e.g., rechargeable battery or capacitor). In this example, the electrical output 207 may be used to charge/recharge one or more energy storage devices, such as a battery and/or capacitor. For instance, the electrical output 207 may be used to charge/recharge a bank of rechargeable batteries and/or capacitors. By way of another example, one or more electrical circuits may be one or more portions (e.g., power supply circuitry) of an electrical device. In this example, the electrical output 207 of the conversion device 200 may be used to directly power any number and type of electrical devices. For the purposes of the present disclosure, the term “electrical device” is interpreted to mean any digital and/or analog device, system or component powered by electricity. By way of another example, the one or more electrical circuits may be one or more electrical circuits of an electrical distribution system. For instance, the electrical output 207 from the conversion device 200 may be coupled to an electrical distribution system, such as one or more electrical grids. In this regard, electricity from the conversion device 200 may be transmitted through the electrical distribution system to an end user or device.

FIG. 2R illustrates a flow diagram 270 depicting a method of converting a scalar particle flow to an electrical output, in accordance with one or more embodiments of the present disclosure. The steps of method 270 may be implemented all or in part by the apparatus embodiments described previously herein. It is noted, however, that method 270 is not limited to the apparatus embodiments described previously herein and may be implemented via a variety of device implementations.

In step 272, an electrolysis current is generated between an anode and a crystalline cathode within an electrolytic fluid. For example, as shown in FIG. 2A, the voltage source 211 may be used to establish an electrolysis current 215 between the anode 204 and crystalline cathode 202 in an electrolytic fluid 203 (e.g., D₂0/LiOH).

In step 274, one or more ion species from the electrolytic fluid are loaded into the crystalline cathode. For example, as shown in FIG. 2E, in the case of a palladium cathode and a D₂O-based electrolytic fluid, deuterium ions from the electrolytic fluid load into the palladium cathode to form PdDx.

In step 276, a portion of a scalar particle flow impinging on the crystalline cathode is converted to photons. For example, as shown in FIG. 2A-2D, the presence of large oscillating magnetic fields within the crystalline cathode 202 cause scalar particles, such as axions, of the scalar particle flow to be converted to photons via the inverse Primakoff effect. Some of these photons 209 are absorbed by the material of the crystalline cathode 202, thereby producing heat, where some photons 213 are converted close enough to a surface of the cathode 202 to be emitted by the cathode 202.

In step 278, a direct conversion or an indirect conversion of the photons from the crystalline cathode into electricity is performed. For example, as shown in FIGS. 2B and 2D, one or more photoelectric devices 219 may be used to directly convert the photons 213 to an electrical output. By way of another example, as shown in FIG. 2A-2B, the photon can be indirectly converted to an electrical output 207 using one or more thermal conversion devices 208 to convert heat generated by the absorption of the inverse Primakoff photons 209 to an electrical output 207.

In step 280, the electricity produced in step 278 is provided to one or more electrical circuits. For example, the electrical output 207 may be coupled to one or more electrical circuits. For example, the electrical output 207 from the conversion device 200 may be used to power any number of electrical circuits of any type of electrical device. The one or more electrical circuits may include or be embodied as an energy storage device (e.g., rechargeable battery or capacitor), one or more electrical circuits of an electrical device, or one or more electrical distribution systems (e.g., an electrical grid).

It is noted that the scope of the present disclosure is not limited to the electrolysis-based implementation depicted in FIGS. 2A-2O, which is provided merely for illustrative purposes. Rather, the scalar conversion process of the present disclosure may be carried out in a variety of device contexts (e.g., gas-based devices and solid-state devices).

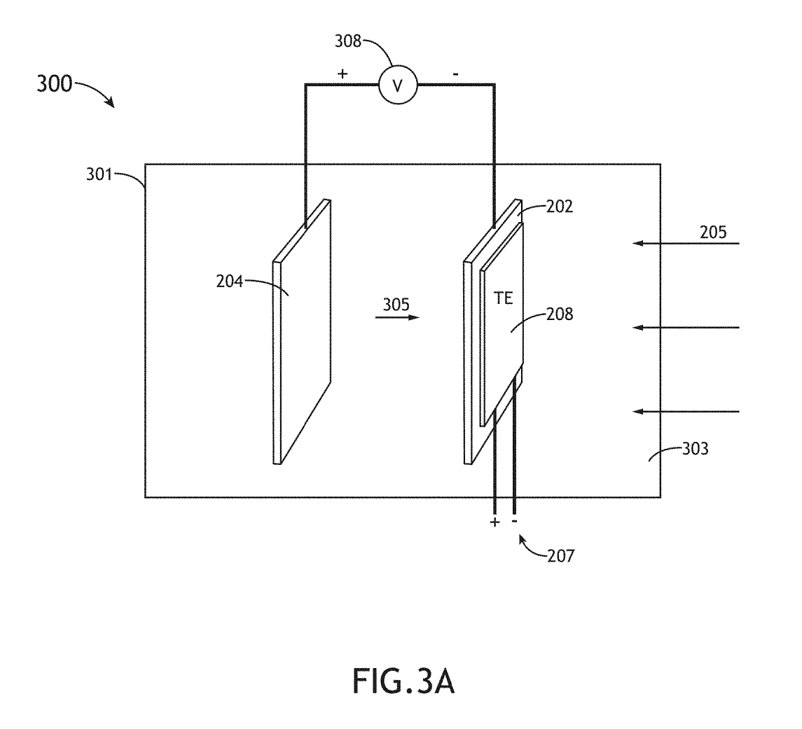

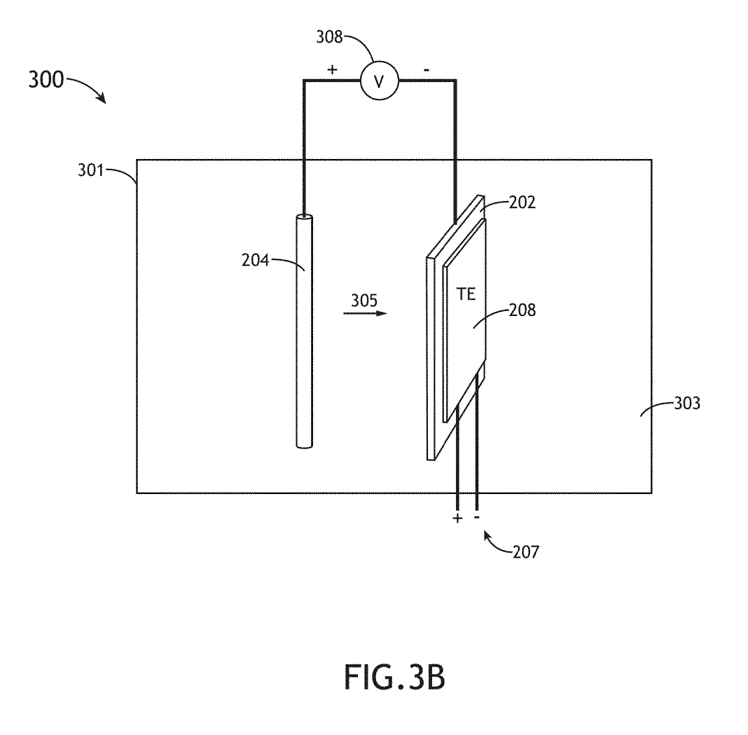

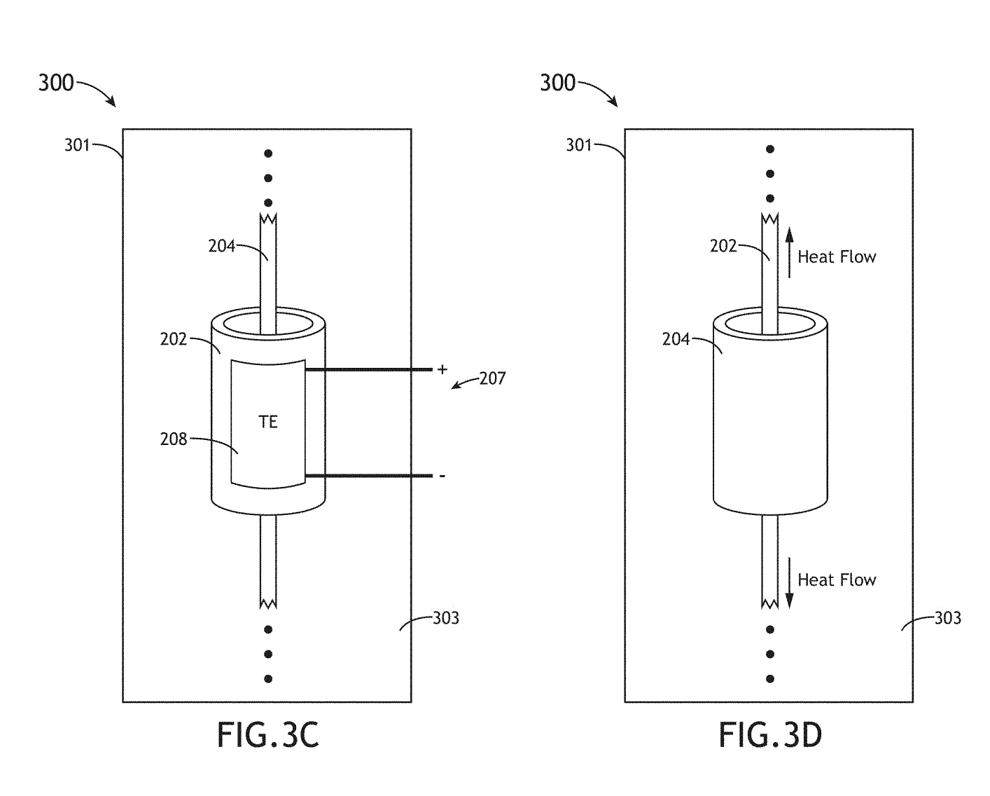

FIGS. 3A-3D illustrate an indirect conversion device 300 equipped with one or more thermal conversion devices, in accordance with one or more embodiments of the present disclosure. It is noted that the various embodiments and components described previously herein with respect to FIGS. 2A-2Q should be interpreted to extend to the embodiment of FIGS. 3A-3D unless otherwise noted. Specifically, it is noted that the various embodiments described previously herein related to the orientation of the cathode 202, the crystal texture of the cathode 202, the triggering source 224, and the like should be interpreted to extend to the embodiments associated with FIGS. 3A-3D.

In one embodiment, the scalar particle conversion device 300 includes the crystalline cathode 202 and the anode 204 disposed within a gas 303. The gas 303 may be contained within a gas chamber 301 at a low pressure. In another embodiment, the voltage source 308 is electrically coupled to the cathode 202 and anode 204 and is configured to generate a discharge current 305 through the gas 303 (e.g., glow discharge current). Further, one or more gas components within the gas are loaded into the crystalline cathode 202.

In one embodiment, the crystalline cathode 202 includes palladium and gas 303 includes deuterium. The gas may include a mixture of deuterium and an inert carrier gas, such as, but not limited to, argon, nitrogen and the like. In another embodiment, the gas 303 may include a deuterium compound, such as, but not limited to, neutron-enriched methane. The gas 303 may be a pure deuterium compound or a mixture of a deuterium compound with an inert carrier gas. The gas 303 may be maintained at a low pressure suitable for establishing a glow discharge current within the gas. For example, the pressure of the gas may be maintained at pressure between approximately 1/10,000 and 1/100 atm.

In the case of a palladium-based crystalline cathode 202, the discharge current 305 established in the gas medium 303 between the anode 204 and cathode 202 serves to drive the electronic instability within the crystalline cathode 202, which cause the atoms in the cathode 202 to experience magnetic field impulses. This process is similar to the magnetic field impulses generated in the electrolysis-based approach described previously herein, the description of which should be interpreted to extend to this embodiment.

In another embodiment, the conversion device 300 includes one or more energy conversion devices. As shown in FIG. 3A, the one or more energy conversion devices may include one or more thermal conversion devices 208 for the indirect conversion of photons generated via the inverse Primakoff effect to an electrical output 207. It is noted that the various arrangements of thermal conversion devices 208 (e.g., thermoelectric device or steam generator systems) described previously herein may be extended to the thermal conversion devices depicted in FIGS. 3A-3D.

The cathode 202 and anode 204 of the conversion device 300 may take on any number of shapes. In one embodiment, as depicted in FIG. 3A, the cathode 202 may take on a foil or plate shape, while the anode 204 also takes on a foil or plate shape. In another embodiment, as depicted in FIG. 3B, the cathode 202 may take on a foil or plate shape, while the anode 204 takes on a cylindrical or wire shape. In another embodiment, as depicted in FIG. 3C, the cathode 202 and anode 204 are arranged such that the anode 204 passes through the cathode 202. For example, as shown in FIG. 3C, the cathode 202 may include a hollow cylindrical structure or tube, while the anode 204 has a cylindrical, wire or filamentary shape and is positioned lengthwise within the cathode 202. In this regard, the discharge current (not shown in FIG. 3C) is between the anode and impinges the internal surface of the cathode 202.

In another embodiment, as depicted in FIG. 3D, the cathode 202 and anode 204 are arranged such that the cathode 202 passes through the hollow anode 204. For example, as shown in FIG. 3D, the anode 204 may include a hollow cylindrical structure or tube, while the cathode 202 has a cylindrical, wire or filamentary shape and is positioned lengthwise within the anode 204. In this regard, the discharge current (not shown in FIG. 3D) radiates inward from the anode 204 and impinges the outer surface of the cathode 202. In this embodiment, heat may flow along the elongated cathode structure, where it may be utilized via one or more thermal conversion devices (not shown in FIG. 3D) in a manner similar that previously described herein to produce an electrical output.

It is recognized that those of ordinary skill in the art, with the benefit of the present disclosure, may recognize a variety of equivalent configurations and embodiments for generating electricity via a thermoelectric device using the gas-based conversion device 300 as a heat source.

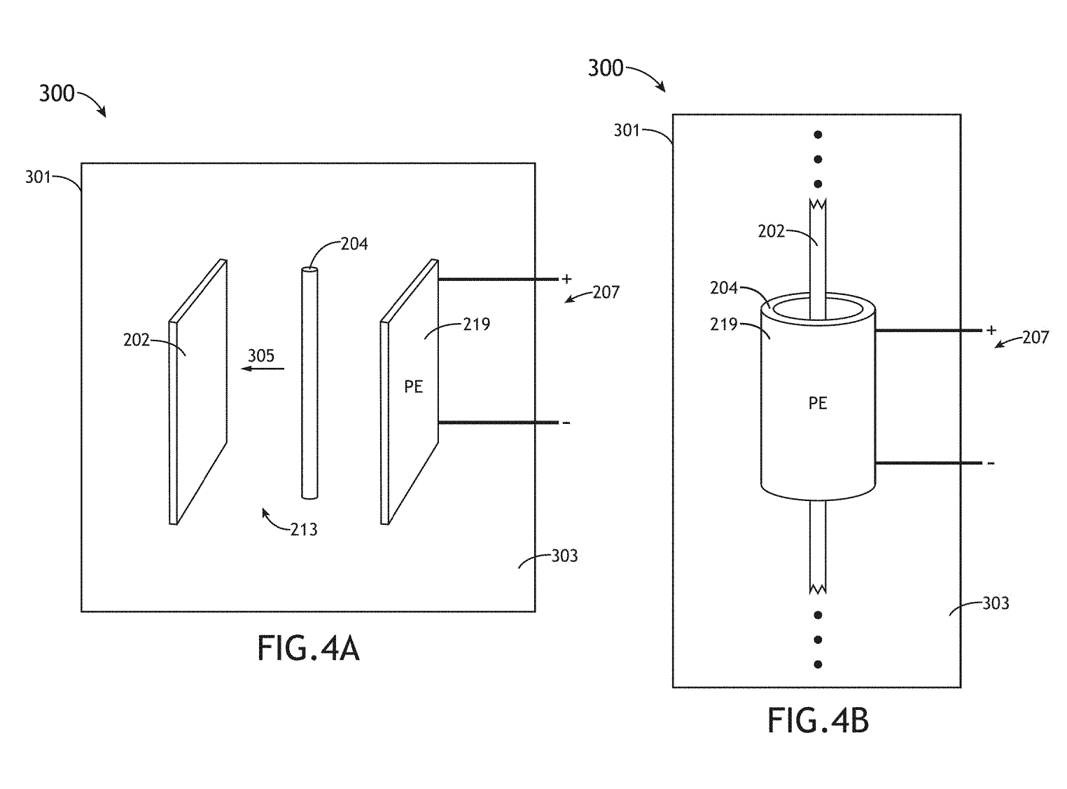

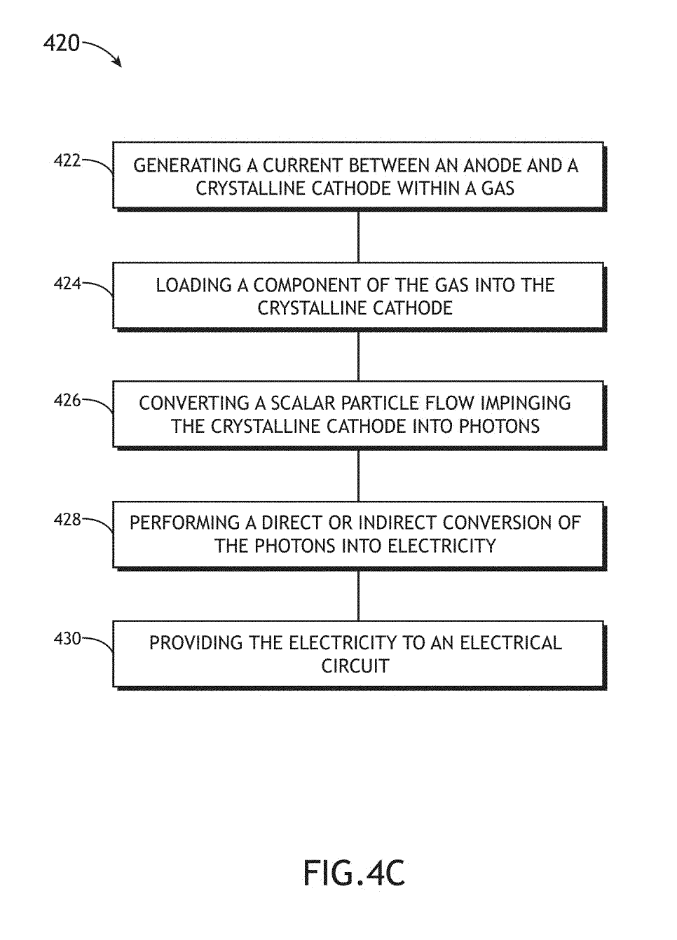

FIGS. 4A-4B illustrate a direct conversion device 300 equipped with one or more photoelectric devices, in accordance with one or more embodiments of the present disclosure. In one embodiment, the conversion device 300 includes one or more photoelectric devices 219 arranged to receive photons 213 emitted from the crystalline cathode 202. The photons 213 emitted by the crystalline cathode 202 are generated by the inverse Primakoff effect through the interaction of the oscillating magnetic fields within the cathode, as discussed previously herein. The one or more photoelectric devices 219 receive the photons 213 and directly convert the photons 213 to an electrical output 207. For example, the one or more photoelectric devices 219 may include one or more low band gap photovoltaic (PV) cells, such as, but not limited to, one or more semiconductor PV cells (e.g., silicon-based PV cell). By way of another example, the one or more photoelectric devices 219 may include one or more quantum cascade devices.

In one embodiment, as shown in FIG. 4A, the cathode 202 includes a foil or plate structure and the anode 204 includes a wire or cylindrical structure. The discharge current 305 between the anode 204 and cathode 202 drives the electronic instability within the crystalline cathode 202 ultimately leading to the emission of photons 213 from one or more surfaces of the cathode 202 in response to a flow of scalar particles (not shown in FIG. 4A for simplicity) via the inverse Primakoff effect. In turn, the photoelectric device 219 receives some portion of the photons 213 and converts the photons to an electrical output 207.

In another embodiment, as shown in FIG. 4B, the cathode 202 and anode 204 are arranged such that the cathode 202 passes through the anode 204. For example, the anode 204 may include a hollow cylindrical structure or tube, while the cathode 202 has a cylindrical, wire or filamentary shape and is positioned lengthwise within the anode 204. In this regard, the discharge current (not shown in FIG. 4B) is between the anode 204 and impinges the internal surface of the cathode 202 and serves to drive the electronic instability within the crystalline cathode 202. In turn, in response to a scalar particle flow (not shown for simplicity) photons (not shown in FIG. 4B) are emitted by the wire cathode 202 via the inverse Primakoff effect. The photons are then captured by the PE device 219. For example, the device 300 may include a transparent anode 204 (e.g., indium tin oxide (ITO) anode), which transmits photons from the cathode to one or more photoelectric devices disposed on the outer surface of the transparent anode 204. Alternatively, the device 300 may include, but is not limited to, an integrated photoelectric anode, which serves as both the anode and the photoelectric converter for the device 300.

It is further noted that the use of one or more photoelectric conversion devices 219 is not limited to the gas-based configuration of device 300 and the use of one or more photoelectric conversion devices may be extended to any of the conversion device configurations described throughout the present disclosure.

FIG. 4C illustrates a flow diagram 420 depicting a method of converting a scalar particle flow to an electrical output, in accordance with one or more embodiments of the present disclosure. The steps of method 420 may be implemented all or in part by the apparatus embodiments described previously herein. It is noted, however, that method 420 is not limited to the apparatus embodiments described previously herein and may be implemented via a variety of device implementations.

In step 422, a current is generated between an anode and a crystalline cathode within a gas. For example, as shown in FIG. 3A, the voltage source 308 may be used to establish a discharge current 305 between the anode 204 and crystalline cathode 202 in a low pressure gas (e.g., low pressure deuterium gas).

In step 424, one or more components from the gas are loaded into the crystalline cathode. For example, in the case of a palladium cathode and deuterium gas, deuterium from the gas 303 may be loaded into the palladium cathode to form PdDx.

In step 426, a portion of a scalar particle flow is converted to photons within the crystalline cathode. For example, as shown in FIG. 3A, the presence of large oscillating magnetic fields within the crystalline cathode 202 cause scalar particles, such as axions, of the scalar particle flow 205 to be converted to photons via the inverse Primakoff effect.

In step 428, a direct conversion or an indirect conversion of the photons from the crystalline cathode into electricity is performed. For example, as shown in FIGS. 4A-4B, one or more photoelectric devices 219 may be used to directly convert the photons 213 to an electrical output. By way of another example, as shown in FIGS. 3A-3D, the photon can be indirectly converted to an electrical output 207 using one or more thermal conversion devices 208 to convert heat generated by the absorption of the inverse Primakoff photons 209 to an electrical output 207.

In step 430, the electricity produced in step 428 is provided to one or more electrical circuits. For example, the electrical output 207 may be coupled to one or more electrical circuits. For example, the electrical output 207 from the conversion device 300 may be used to power any number of electrical circuits of any type of electrical device. The one or more electrical circuits may include or be embodied as an energy storage device (e.g., rechargeable battery or capacitor), one or more electrical circuits of an electrical device, or one or more electrical distribution systems (e.g., an electrical grid).

It is recognized that those of ordinary skill in the art, with the benefit of the present disclosure, may recognize a variety of equivalent configurations and embodiments for generating electricity via a photoelectric device using the gas-based conversion device 300 as a photon source.

FIGS. 5A-5C illustrate a scalar particle conversion device 500, in accordance with one or more embodiments of the present disclosure. It is noted that the various embodiments and components described previously herein with respect to FIGS. 2A-4C should be interpreted to extend to the embodiment of FIGS. 5A-5C unless otherwise noted.

In one embodiment, the conversion device 500 includes a volume of particulate material 502 consolidated within a container 504. For example, the container 504 may include, but is not limited to, a tube or pipe. In another embodiment, the particulate material may include, but is not limited to, a powder or volume of nanoparticles.

In another embodiment, the volume of particulate material 502 is held at a high pressure (e.g., pressure greater than 1 atm). For example, the volume of consolidated particulate material 502 may be held at a high pressure in a selected gas 503 using the same container 504 used to consolidate the particulate material 502. By way of another example, as depicted in FIG. 5A, the conversion device 500 includes a gas chamber 501, which maintains the volume of particulate material contained within the container 504 at a high pressure in a selected gas. For example, the conversion device 500 may maintain the particulate material 502 at a pressure between 1 and 20 atm, such as, but not limited to, a pressure between about 3 and 5 atm.

In another embodiment, the particulate material 502 is heated to a selected temperature. For example, the particulate material 502 may be heated to a temperature between about 500 and 1500° C.

In one embodiment, the particulate material 502 includes a palladium, a nickel, a platinum or gold powder. In one embodiment, the particulate material 502 includes powdered palladium or palladium nanoparticles. In this embodiment, the gas 503 may include a deuterium gas or a gaseous deuterium compound (or mixture of an inert gas with deuterium gas or a gaseous deuterium compound). In this embodiment, pressurized deuterium gas (e.g., 2-5 atm) may cause the loading of deuterium into the palladium particulate material 502 so as to form PdDx analogously to the deuterium loading of palladium discussed previously herein. In addition, the heating of the PdDx particulate material acts to thermally activate phonons within the PdDx material in order to achieve the electronic phase transition, discussed previously herein, and produce a large magnetic field (e.g., greater than 6000 T) for scalar particle conversion to photons within the material 502. Nanoparticles suitable for use in this embodiment are discussed by Katti et al. in U.S. Patent Publication No. 2017/0009366, published on Jan. 12, 2017, which is incorporated herein by reference in the entirety.

In another embodiment, the particulate material 502 includes powdered nickel or nickel nanoparticles. In this embodiment, the gas 503 may include a hydrogen gas or a gaseous hydrogen compound (or mixture of an inert gas with hydrogen gas or gaseous hydrogen compound). In this embodiment, pressurized hydrogen gas (e.g., 2-5 atm) may load into the nickel particulate material 502 so as to form NiHx. In addition, the heating of the NiHx particulate material acts to thermally activate phonons within the NiHx material in order to achieve an electronic phase transition and produce a large magnetic field for scalar particle conversion to photons within the material 502. Consolidated nickel powder is discussed in international publication no. WO 2009/125444 A1 to Rossi, published on Oct. 15, 2009, which is incorporated herein by reference in the entirety.

In one embodiment, in the case of nanoparticles, the nanoparticles may be ferromagnetic and may be magnetically polarized. For example, the nanoparticles may include palladium, nickel, platinum or gold nanoparticles having an average diameter of approximately 1 to 4 nm, such as between 2 and 3 nm. Such particles become ferromagnetic in this size range. In addition, the nanoparticles may be magnetically polarized to enhance the conversion of scalar particles to photons.

In another embodiment, the volume of particulate material 502 may be arranged so as to present the maximum surface area to the direction of the scalar particle flow 205. For example, in the case of a cylindrical structure, the volume of particulate material 502 should be oriented such that the axis of the cylinder is oriented at approximately 90 degrees with respect to the scalar particle flow 205.

In another embodiment, as depicted in FIGS. 5B and 5C, the conversion device 500 includes one or more energy conversion devices for the indirect or direct conversion of photons to an electrical output 207. For example, as shown in FIG. 5B, one or more thermal conversion devices 208 may be utilized to convert excess heat from the particulate material 502 to an electrical output 207 as described throughout the present disclosure. By way of another example, as shown in FIG. 5C, one or more photoelectric conversion devices 219 may be utilized to convert photons emitted from the particulate material 502 to an electrical output 207 as described throughout the present disclosure.

It is noted herein that the conversion device 500 is not limited to the cylindrical shape depicted in FIGS. 5A-5C, which is provided merely for illustrative purposes. For example, the shape of the volume of consolidated particulate material of device 500 may take on any shape known in the art such as, but not limited to, a cylinder, a bar, a parallelepiped (e.g., plate) or a sphere.

FIG. 5D illustrates a flow diagram 520 depicting a method of converting a scalar particle flow to an electrical output, in accordance with one or more embodiments of the present disclosure. The steps of method 520 may be implemented all or in part by the apparatus embodiments described previously herein. It is noted, however, that method 520 is not limited to the apparatus embodiments described previously herein and may be implemented via a variety of device implementations

In step 522, a volume of consolidated particulate material within gas having a pressure greater than 1 atm is heated. For example, as shown in FIG. 5A, a volume of particulate material (e.g., powder or nanoparticles) are heated to a temperature between about 500 and 1500° C. Further, the particulate material may be maintained in a pressurized gas (e.g., deuterium gas) at a pressure between 1 and 20 atm. For instance, the particulate material may be maintained in a pressurize gas at a pressure between about 3 and 5 atm.

In step 524, a portion of a scalar particle flow impinging on the consolidated particulate material is converted into photons via the inverse Primakoff effect.

In step 526, a direct conversion or indirect conversion of the photons from the consolidated particulate material into electricity is performed. For example, as shown in FIG. 5C, one or more photoelectric devices 219 may be used to directly convert the photons 213 to an electrical output. By way of another example, as shown in FIG. 5B, the photons can be indirectly converted to an electrical output 207 using one or more thermal conversion devices 208 to convert heat generated by the absorption of the inverse Primakoff photons 209 to an electrical output 207.

In step 528, the electricity produced in step 526 is provided to one or more electrical circuits. For example, the electrical output 207 may be coupled to one or more electrical circuits. For example, the electrical output 207 from the conversion device 200 may be used to power any number of electrical circuits of any type of electrical device. The one or more electrical circuits may include or be embodied as an energy storage device (e.g., rechargeable battery or capacitor), one or more electrical circuits of an electrical device, or one or more electrical distribution systems (e.g., an electrical grid)

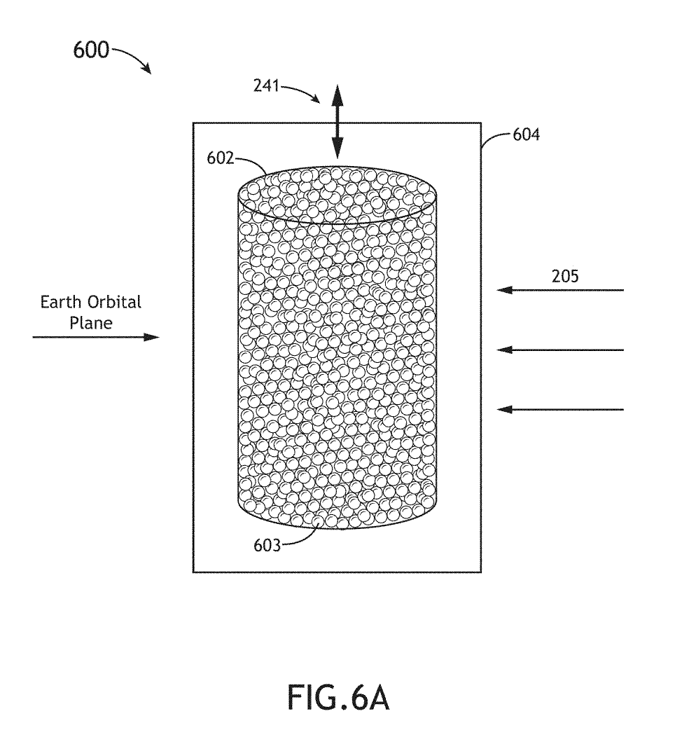

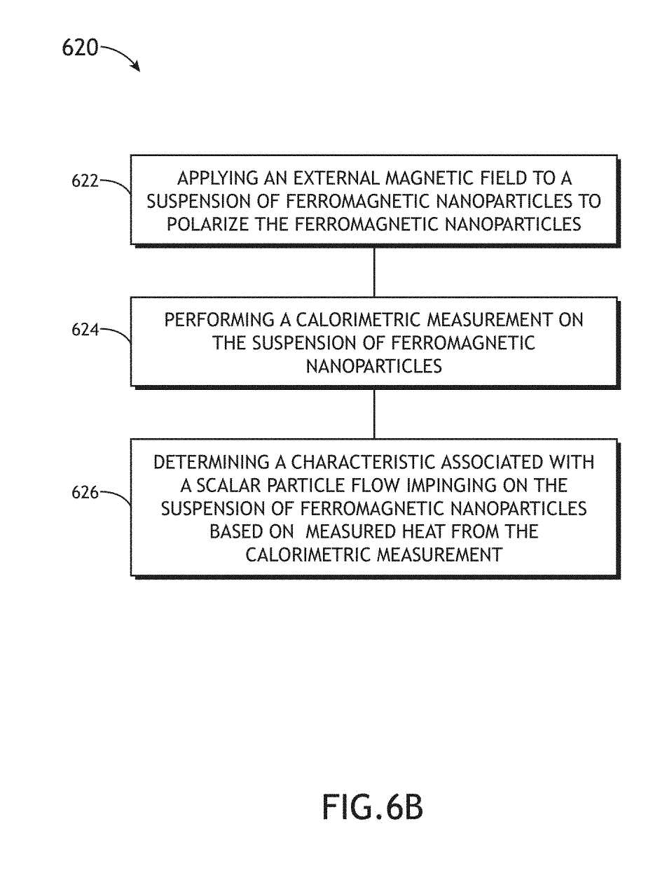

FIG. 6A illustrate a scalar particle detector 600, in accordance with one or more embodiments of the present disclosure. It is noted that the various embodiments and components described previously herein with respect to FIGS. 2A-5D should be interpreted to extend to the embodiment of FIGS. 6A-6B unless otherwise noted.

In one embodiment, the scalar particle detector 600 includes a volume of ferromagnetic nanoparticles 603 consolidated within a container 602 in a closely packed suspension. For examples, the nanoparticles 603 may include, but are not limited to, gold, palladium or platinum nanoparticles. For instance, the nanoparticles 603 may have an average size (i.e., diameter) of approximately 1-4 nm or, more specifically, 2-3 nm. It is noted that gold, palladium or platinum may become ferromagnetic in this size range. For example, Au has a 2000 T internal magnetic field (see Table I). It is noted that if ferromagnetic alignment is established in a significant volume of nanoparticles the volume of nanoparticles 603 may present a large magnetic field to the flow of scalar particles 205. Nanoparticles suitable for use in this embodiment are discussed by Katti et al. in U.S. Patent Publication No. 2017/0009366, published on Jan. 12, 2017, which is incorporated previously herein by reference in the entirety.

In another embodiment, an external magnetic field 241 may be applied so as to polarize the nanoparticle suspension within the volume of nanoparticles 603 and enhance the magnetic field(s) within the volume of nanoparticles 603 and, thus the photon/heat generation via the inverse Primakoff effect. For example, as discussed previously herein, an external magnetic field generator 240 may be used to establish a magnetic field perpendicular to the scalar particle flow 205. As shown in FIG. 6A, the external magnetic field 241 may be oriented perpendicularly to the scalar particle flow 205, whereby the field 241 is oriented along the axial direction of a cylindrical volume of nanoparticles 603 and perpendicular to the Earth's orbital plane. Alternatively, the external magnetic field may be applied perpendicularly to the scalar particle flow 205 and the Earth's orbital plane by aligning the magnetic field in a direction perpendicular to the axial direction of the volume of nanoparticles (i.e., into the page of FIG. 6A).

In another embodiment, a thermal gradient is applied across the volume of ferromagnetic nanoparticles. The thermal gradient applied across the volume of magnetic nanoparticles may serve to thermally excite phonons within the ferromagnetic particles.

In another embodiment, the detector device 600 includes a calorimeter device 604 surrounding at least a portion of the volume of nanoparticles 603. The calorimeter 604 may include any number of heat detection devices (e.g., thermocouples, RTDs, etc.) to measure the heat released by the volume of nanoparticles 603 via the inverse Primakoff effect. The scalar particle detection device 600 would yield a relatively constant signal when in a fixed orientation and can be used for point measurements of the scalar particle density (e.g., axion density) at any location (e.g., positions within the solar system). It is noted that an enhancement of 10̂12 may be maintained in the scalar particle detection probability. It is further noted that the device 600 should convert any scalar particle mass greater than approximately 1 meV.

In another embodiment, as discussed previously herein, the volume of ferromagnetic nanoparticles may have a selected shape including, but not limited to, a foil, a bar, a cylinder or a parallelepiped

It is noted that the nanoparticle configuration of the present disclosure is not limited to the calorimetry configuration depicted in FIG. 6A, which is provided merely for purposes of illustration. It is noted that the device 600 may be configured as an energy conversion device rather than as a scalar particle detector. In this case, the calorimeter 604 of the device maybe replaced with one or more direct conversion devices (e.g., photoelectric devices) or one or more indirect conversion devices (e.g., thermoelectric devices or steam generator systems) for producing an electrical output from the photons/heat generated within the volume of nanoparticles 603 via the inverse Primakoff effect. This configuration would be similar to device 500 depicted in FIGS. 5A-5C with the volume of particular material in FIGS. 5A-5C replaced with the volume of nanoparticles 603.

FIG. 6B illustrates a flow diagram 620 depicting a method of detecting scalar particles, in accordance with one or more embodiments of the present disclosure. The steps of method 620 may be implemented all or in part by the apparatus embodiments described previously herein. It is noted, however, that method 620 is not limited to the apparatus embodiments described previously herein and may be implemented via a variety of device implementations

In step 622, an external magnetic field is applied to a suspension of ferromagnetic nanoparticles contained within a container to at least partially polarize at least some of the ferromagnetic nanoparticles. For example, as shown in FIG. 6A, an external magnetic field 241 is applied to a suspension of ferromagnetic nanoparticles 603 contained within a container 602 to at least partially polarize the ferromagnetic nanoparticles 603.

In step 624, calorimetry is performed on the suspension of ferromagnetic nanoparticles by measuring the heat generated by the ferromagnetic nanoparticles. For example, a calorimeter arranged to surround the suspension of ferromagnetic particles 603 is configured to measure the heat put off by the suspension of ferromagnetic particles 603.

In step 626, one or more characteristics associated with a scalar particle flow impinging on the suspension of ferromagnetic nanoparticles are determined based on the measured heat. For example, although not shown, a digital or analog output from the calorimeter 604 may be collected by a controller/computer system (e.g., controller including one or more processors and memory). The calorimeter measurements may be recorded as a function of a selected parameter (e.g., time, position of device 600, orientation of suspension of nanoparticles, etc.). Then, based on signatures within the recorded calorimeter data scalar particle detection events can be determined and recorded.

While the various embodiments of the present disclosure have focused on the conversion of scalar particles via crystalline magnetic fields, it is noted herein that this approach should not be interpreted as a limitation on the scope of the present disclosure. It is recognized herein that very large crystal electric fields may exist in crystalline materials when modulated by a crystal resonance. Applicants contemplate herein the conversion of scalar particles via large crystal electrical fields, which is analogous to the conversion of scalar particles to photons via large magnetic fields. The concepts discussed previously herein with respect to magnetic field conversion are completely analogous to the case of electric field based conversion and should be interpreted to extend to the case of conversion using dynamic electric crystal fields. As previously discussed, it is again noted that the Lagrangian in Eq. 3 can also be used to quantify the possibility of an axion-photon conversion event by large solid-state static or dynamic electric fields coupled to the virtual electromagnetic B field. For example, crystals such as, but not limited to, BaTiO₃ and SrTiO₃, display very large crystal electric fields when modulated by a crystal resonance. These and similar crystal systems may be used as a conversion medium for electric field based scalar particle conversion.

All of the methods described herein may include storing results of one or more steps of the method embodiments in a memory medium. The results may include any of the results described herein and may be stored in any manner known in the art. The memory medium may include any memory medium described herein or any other suitable memory medium known in the art. After the results have been stored, the results can be accessed in the memory medium and used by any of the method or system embodiments described herein, formatted for display to a user, used by another software module, method, or system, etc. Furthermore, the results may be stored “permanently,” “semi-permanently,” temporarily, or for some period of time. For example, the memory medium may be random access memory (RAM), and the results may not necessarily persist indefinitely in the memory medium.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically interactable and/or physically interacting components and/or wirelessly interactable and/or wirelessly interacting components and/or logically interactable and/or logically interacting components.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

One skilled in the art will recognize that the herein described components, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, devices, and objects should not be taken limiting. While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

1. A scalar particle conversion apparatus for conversion of scalar particles to electricity comprising:
an anode and a crystalline cathode disposed within an electrolytic fluid;
a voltage source electrically coupled to the anode and the cathode and configured to generate an electrolysis current between the anode and the cathode, wherein one or more ion species from the electrolytic fluid are loaded into the crystalline cathode,
wherein the crystalline cathode generates photons via an interaction between one or more scalar particles of a scalar particle flow with one or more oscillating magnetic hyperfine fields within the crystalline cathode via an inverse Primakoff effect; and
one or more energy conversion devices operatively coupled to one or more portions of the crystalline cathode and configured to perform at least one of a direct or indirect conversion of the photons from the crystalline cathode to an electrical output.

2. The apparatus of claim 1, wherein at least a portion of the scalar particle flow is converted to photons within the volume of the crystalline cathode via resonance between the phonon frequency of the crystalline cathode and the mass frequency of the scalar particles of the scalar particle flow.

3. The apparatus of claim 1, wherein a selected surface of the crystalline cathode is arranged substantially perpendicular to a direction of the scalar particle flow.

4. The apparatus of claim 3, wherein the crystalline cathode is arranged so as to present a maximum surface area of the crystalline cathode to the direction of the scalar particle flow.

5. The apparatus of claim 4, wherein a magnitude of energy production by the crystalline cathode is proportional to the cosine of an angle between a direction normal to the maximum surface area and a direction of the scalar particle flow.

6. The apparatus of claim 1, wherein the crystalline cathode is oriented to compensate for Earth's tilt relative to the orbital plane of the Earth around the Sun such that a selection dimension of the crystalline cathode is perpendicular to the Earth's orbital plane.

7. The apparatus of claim 1, wherein the voltage source is configured to apply a pulsed electrical current to the crystalline cathode to drive a phonon frequency of the crystalline cathode into resonance with a mass frequency of the scalar particles of the scalar particle flow.

8. The apparatus of claim 1, further comprising:
an external pulsed energy source configured to impart energy to the crystalline cathode to drive a phonon frequency of the crystalline cathode into resonance with a mass frequency of the scalar particles of the scalar particle flow.

9. The apparatus of claim 8, wherein the external pulsed energy source comprises:
an acoustic generator configured to impart pulsed sound waves onto the crystalline cathode.

10. The apparatus of claim 8, wherein the external pulsed energy source comprises:
one or more lasers configured to direct pulsed laser light onto the crystalline cathode.

11. The apparatus of claim 8, wherein the external pulsed energy source comprises:
an RF generator configured to direct pulsed radio frequency radiation onto the crystalline cathode.

12. The apparatus of claim 1, further comprising:
an external magnetic field generator configured to generate an external magnetic field for polarizing the atoms of the crystalline cathode, wherein the external magnetic field is aligned substantially perpendicular to a direction of the scalar particle flow.

13. The apparatus of claim 12, wherein a magnitude of heat production by the crystalline cathode is proportional to the sine of an angle between a direction of the external magnetic field and the direction of the scalar particle flow.

14. The apparatus of claim 1, wherein the crystalline cathode is formed from palladium (Pd) and the electrolytic fluid includes heavy water, wherein deuterium (D) from the heavy water loads the cathode to form PdDₓ, wherein x is greater than about 0.3.

15. The apparatus of claim 14, wherein the deuterium loads within the palladium at interstitial locations within a palladium lattice of the crystalline cathode.

16. The apparatus of claim 14, wherein one or more surfaces of the crystalline cathode formed from palladium have a labyrinth surface morphology.

17. The apparatus of claim 14, wherein the crystalline cathode formed from palladium is crystallographically textured, wherein the crystalline cathode is arranged such that a <100> direction of the crystalline cathode is at least one of substantially parallel to a direction of the scalar particle flow or substantially perpendicular to the direction of the scalar particle flow.

18. The apparatus of claim 1, wherein the cathode is formed from nickel (Ni) and the electrolytic fluid includes water, wherein hydrogen (H) from the water loads the cathode to form NiHₓ, wherein x is greater than about 0.3.

19. The apparatus of claim 1, wherein the crystalline cathode has a selected shape including a least one of a foil, a wire, a cylinder, or a parallelepiped.

20. The apparatus of claim 1, wherein the energy conversion device comprises:
one or more photoelectric conversion devices arranged to receive at least a portion of the photons from one or more surfaces of the crystalline cathode, wherein the one or more photoelectric conversion devices are configured to directly convert at least a portion of the photons from the crystalline cathode to an electrical output.

21. The apparatus of claim 1, wherein at least a portion of the photons converted from the scalar particle flow are absorbed by the crystalline cathode to generate heat.

22. The apparatus of claim 21, wherein the one or more energy conversion devices comprises:
one or more thermal conversion devices thermally coupled to the crystalline cathode, wherein the one or more thermal conversion devices are configured to indirectly convert at least a portion of the photons from the crystalline cathode to the electrical output by converting the heat generated by the absorption of photons within the crystalline cathode to an electrical output.

23. The apparatus of claim 21, wherein the one or more thermal conversion devices comprise:
at least one of one or more thermoelectric devices or one or more steam generators.

24. (canceled)

25. (canceled)

26. (canceled)

27. A scalar particle conversion apparatus for conversion of scalar particles to electricity comprising:
an anode and a crystalline cathode disposed within a gas;
a voltage source electrically coupled to the anode and the crystalline cathode and configured to generate a current through the gas, wherein a component of the gas is loaded into the crystalline cathode,
wherein a portion of a scalar particle flow impinging on the crystalline cathode is converted to photons via the inverse Primakoff effect; and
one or more energy conversion devices operatively coupled to one or more portions of the crystalline cathode and configured to perform at least one of a direct or indirect conversion of the photons from the crystalline cathode to an electrical output.

28. The apparatus of claim 27, wherein the portion of the scalar particle flow converted to photons via the inverse Primakoff through an interaction of the scalar particles of the scalar particle flow with oscillating magnetic hyperfine fields within the crystalline cathode.

29. The apparatus of claim 28, wherein at least a portion of the scalar particle flow is converted to photons within the volume of the crystalline cathode via resonance between the phonon frequency of the crystalline cathode and the mass frequency of the scalar particles of the scalar particle flow.

30. The apparatus of claim 27, wherein a selected surface of the crystalline cathode is arranged substantially perpendicular to a direction of the scalar particle flow.

31. The apparatus of claim 30, wherein the crystalline cathode is arranged so as to present a maximum surface area of the crystalline cathode to the direction of the scalar particle flow.

32. The apparatus of claim 31, wherein a magnitude of energy production by the crystalline cathode is proportional to the cosine of an angle between a direction normal to the maximum surface area and a direction of the scalar particle flow.

33. The apparatus of claim 27, wherein the crystalline cathode is oriented to compensate for Earth's tilt relative to the orbital plane of the Earth around the Sun such that a selected dimension of the crystalline cathode is perpendicular to the Earth's orbital plane.

34. The apparatus of claim 27, wherein the voltage source is configured to apply a pulsed electrical current to the crystalline cathode to drive a phonon frequency of the crystalline cathode into resonance with a mass frequency of the scalar particles of the scalar particle flow.

35. The apparatus of claim 27, further comprising:
an external pulsed energy device configured to impart energy to the crystalline cathode to drive a phonon frequency of the crystalline cathode into resonance with a mass frequency of the scalar particles of the scalar particle flow.

36. The apparatus of claim 35, wherein the external stimulator device comprises:
an acoustic generator configured to impart pulsed sound waves onto the crystalline cathode.

37. The apparatus of claim 35, wherein the external stimulator device comprises:
one or more lasers configured to direct pulsed laser light onto the crystalline cathode.

38. The apparatus of claim 35, wherein the external stimulator device comprises:
an RF generator configured to direct pulsed radio frequency radiation onto the crystalline cathode.

39. The apparatus of claim 27, further comprising:
an external magnetic field generator configured to generate an external magnetic field for polarizing the atoms of the crystalline cathode, wherein the external magnetic field is aligned substantially perpendicular to a direction of the scalar particle flow.

40. The apparatus of claim 39, wherein a magnitude of heat production by the crystalline cathode is proportional to the sine of an angle between a direction of the external magnetic field and the direction of the scalar particle flow.

41. The apparatus of claim 27, wherein the crystalline cathode is formed from palladium (Pd) and the gas includes deuterium (D), wherein deuterium loads the cathode to form PdDₓ, wherein x greater than about 0.3.

42. The apparatus of claim 41, wherein the deuterium loads within the palladium at interstitial locations within a palladium lattice of the crystalline cathode.

43. The apparatus of claim 41, wherein one or more surfaces of the crystalline cathode formed from palladium have a labyrinth surface morphology.

44. The apparatus of claim 41, wherein the crystalline cathode formed from palladium is crystallographically textured, wherein the crystalline cathode is arranged such that a <100> direction of the crystalline cathode is at least one of substantially parallel to the scalar particle flow or substantially perpendicular to the direction of the scalar particle flow.

45. The apparatus of claim 27, wherein the crystalline cathode is formed from nickel (Ni) and the electrolytic fluid includes water, wherein hydrogen (H) from the water loads the cathode to form NiHₓ, where x is greater than about 0.3.

46. The apparatus of claim 27, wherein the energy conversion device comprises:
one or more photoelectric conversion devices arranged to receive at least a portion of the photons from one or more surfaces of the crystalline cathode, wherein the one or more photoelectric conversion devices are configured to directly convert at least a portion of the photons from the crystalline cathode to an electrical output.

47. The apparatus of claim 27, wherein at least a portion of the photons converted from the scalar particle flow are absorbed by the crystalline cathode to generate the heat.

48. The apparatus of claim 47, wherein the one or more energy conversion devices comprises:
one or more thermal conversion devices thermally coupled to the crystalline cathode, wherein the one or more thermal conversion devices are configured to indirectly convert at least a portion of the photons from the crystalline cathode to the electrical output by converting the heat generated by the absorption of photons within the crystalline cathode to an electrical output.

49. The apparatus of claim 27, wherein the crystalline cathode has a selected shape including a least one of a foil, a wire, a cylinder, or a parallelepiped.

50. The apparatus of claim 27, wherein the anode has a selected shape including a least one of a foil, a wire, a cylinder, or a parallelepiped.

51. The apparatus of claim 27, wherein the crystalline cathode surrounds the anode.

52. The apparatus of claim 27, wherein the anode surrounds the crystalline cathode.

53. (canceled)

54. (canceled)

55. (canceled)

56. A scalar particle conversion apparatus for conversion of scalar particles to electricity comprising:
a container;
a volume of particulate material consolidated within the container, wherein the volume of consolidated particulate material is maintained at a pressure greater than 1 atm;
one or more heating elements configured to heat the volume of the particulate material to a selected temperature,
wherein a portion of a scalar particle flow impinging on the volume of the particulate material is converted to photons via the inverse Primakoff effect; and
one or more energy conversion devices operatively coupled to one or more portions of the volume of the particulate material and configured to perform at least one of a direct or indirect conversion of the photons from the volume of the particulate material to an electrical output.

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. A solid state scalar particle detector comprising:
a container;
a volume of ferromagnetic nanoparticles consolidated within the container in a closely packed suspension;
an external magnetic field generator configured to apply an external magnetic field perpendicular to a scalar particle flow impinging on the volume of ferromagnetic nanoparticles, wherein a portion of a scalar particle flow impinging on the volume of ferromagnetic nanoparticles is converted to photons via the inverse Primakoff effect, wherein at least a portion of the photons converted from the scalar particle flow are absorbed by the ferromagnetic nanoparticles to generate heat; and
a calorimeter, wherein the container containing the volume of ferromagnetic nanoparticles is disposed within the calorimeter, wherein the calorimeter is configured to measure the heat generated by the impingement of the scalar particle flow on the volume of ferromagnetic nanoparticles.

75. (canceled)

76. (canceled)

77. (canceled)

78. (canceled)

79. (canceled)

80. (canceled)
